(19) United States
(12) Patent Application Publication
(10) Pub. No.: US 2019/0147487 A1
(43) Pub. Date: May 16, 2019

(54) APPARATUS FOR EXCHANGING ADVERTISING MEDIA AND METHOD FOR THE SAME

(71) Applicant: GENIEWORKS, INC, Seoul (KR)

(72) Inventor: Ang LEE, Seoul (KR)

(73) Assignee: GENIEWORKS, INC, Seoul (KR)

(21) Appl. No.: 15/840,596

(22) Filed: Dec. 13, 2017

(30) Foreign Application Priority Data
Nov. 14, 2017 (KR) 10-2017-0151531

(51) Int. Cl. G06Q 30/02

(52) U.S. Cl. CPC G06Q 30/0239; G06Q 30/0276; G06Q 30/0208; G06Q 30/0209; G06Q 30/0267

(57) ABSTRACT

Disclosed herein is an apparatus for exchanging advertising media, which includes a candidate event determining unit for determining one or more candidate events interchangeable with a prize event, an exchange ratio determining unit for determining an exchange ratio between the prize event and an exchange target event to be interchanged with the prize event, which is determined based on the candidate events, and a media exchange unit for allocating the prize event to an advertising media corresponding to the exchange target event based on the exchange ratio.

### CROSS REFERENCE TO RELATED APPLICATION

This application claims the benefit of Korean Patent Application No. 10-2017-0151531, filed Nov. 14, 2017, which is hereby incorporated by reference in its entirety into this application.

### BACKGROUND OF THE INVENTION

### 1. Technical Field

The present invention relates generally to an apparatus and method for exchanging advertising media, and more particularly to an apparatus and method for providing the function of exchanging media by allocating respective events of multiple advertising media to another's advertising media.

### 2. Description of the Related Art

These days, smartphone applications may be easily provided through an Application Store (App Store), and various kinds of services using smartphone applications and the web are being provided through a preinstalled mobile WebKit.

Business operators who provide products or services always want to expose their products and services to people using efficient advertisement. In the past, conventional media, such as televisions, newspapers, and the like, were used for advertising, but now, with the development of online media, it is common to use online sites and Social Network Services (SNSs) for advertising. When an advertisement is posted on online sites or SNSs, a promotion is offered or an event is held in order to attract public attention. Here, a promotion or event focuses on a method for offering benefits to a small number of people.

Meanwhile, in order to advertise products, various advertising methods are being used. However, whenever a new advertising campaign is planned, an advertiser must newly design, produce, and manage an advertisement with the help of an advertising agency, which is inefficient. Many big advertisers entrust advertising agencies with tasks related to events and promotion, and the advertising agencies earn profits by planning, designing and running the events and promotion on behalf of the advertisers, but small advertisers plan, design and run events and promotion by themselves. The main reason for events or promotion is to entice new subscribers or to retain existing subscribers, and to this end, such an event or promotion is posted and advertised. However, it is expensive to use advertising agencies in order to post and provide advertising content. Therefore, a method for lowering the expense of showing advertising content is required, and a method for showing advertising content in a cost-effective manner is required.

The above-described information about the related art has been retained by the inventors for the purpose of developing the present invention or was obtained during the process of developing the present invention. Also, it should be appreciated that this information did not necessarily belong to the public domain before the patent filing date of the present invention.

### DOCUMENTS OF RELATED ART

(Patent Document 1) Korean Patent Application Publication No. 10-2015-0001876.

### SUMMARY OF THE INVENTION

An object of the present invention is to provide an apparatus and method for exchanging advertising media between users.

Another object of the present invention is to provide an apparatus and method for exchanging advertising media, in which an exchange ratio is set in consideration of information about events and media.

A further object of the present invention is to provide an apparatus and method for exchanging adverting media, in which candidate events are selected using the correlation between media, the correlation between events, and the correlation of media with events, and the like, and in which the event to be interchanged is selected from among the candidate events.

Yet another object of the present invention is to provide an apparatus and method for creating an advertising event by adding content obtained from a content library in the advertising event and for interchanging the created advertising event with another advertising event through the exchange of advertising media.

Still another object of the present invention is to provide an apparatus and method for creating an effective advertising event for an advertiser based on collected statistical information and interchanging the created advertising event with another advertising event through the exchange of advertising media.

An embodiment of the present invention provides an apparatus for exchanging advertising media, which includes a candidate event determining unit for determining one or more candidate events interchangeable with a prize event; an exchange ratio determining unit for determining an exchange ratio between the prize event and an exchange target event to be interchanged therewith, which is determined based on the candidate events; and a media exchange unit for allocating the prize event to an exchange target advertising media corresponding to the exchange target event based on the exchange ratio.

Here, the candidate event determining unit may determine the candidate events in consideration of one or more of a period factor calculated based on an event period of the prize event and an event period of the candidate event, a media utility factor of a prize event advertising media corresponding to the prize event and a candidate advertising media corresponding to the candidate event, and a prize factor calculated based on information about a prize of the prize event and a prize of the candidate event.

Here, the exchange ratio determining unit may determine the exchange ratio using a first exchange index corresponding to the prize event and a second exchange index corresponding to the exchange target event.

Here, the first exchange index may be calculated in consideration of one or more of information about the event period of the prize event, information about the prize of the prize event, and information about utility of the prize event advertising media, and the second exchange index may be calculated in consideration of one or more of information about an event period of the exchange target event, information about a prize of the exchange target event, and information about utility of the exchange target advertising media corresponding to the exchange target event.

Here, the exchange ratio determining unit may monitor progress status information of events during the event period of the prize event, and may update the exchange ratio based on the progress status information within the event period.

Here, the exchange ratio determining unit may calculate a probability of winning the prize event during the event period of the prize event, and may update the exchange ratio based on the probability within the event period.

Here, when a number of participants in the prize event does not reach a preset level during the event period of the prize event, the exchange ratio determining unit may update the exchange ratio within the event period such that the prize event is more frequently shown as the probability of winning the prize event is higher.

Here, the prize factor may be calculated based on a prize evaluation index that is calculated by dividing a value of a total prize of an event by a number of winners.

Here, the apparatus may further include an expense calculation unit for calculating an expense including one or more of a fee for exchange of the advertising media and an additional expense incurred during the exchange of the advertising media.

Here, the exchange ratio may be set to a ratio between exchange indices, a preset preference ratio, or a ratio of exchange indices modified by incorporating a preset additional expense therein.

Another embodiment of the present invention provides a method for exchanging advertising media, which includes determining one or more candidate events interchangeable with a prize event; determining an exchange ratio between the prize event and an exchange target event to be interchanged therewith, which is determined based on the candidate events; and allocating the prize event to an exchange target advertising media corresponding to the exchange target event based on the exchange ratio.

Here, determining the one or more candidate events may be configured to determine the candidate events in consideration of one or more of a period factor calculated based on an event period of the prize event and an event period of the candidate event, a media utility factor of a prize event advertising media corresponding to the prize event and a candidate advertising media corresponding to the candidate event, and a prize factor calculated based on information about a prize of the prize event and a prize of the candidate event.

Here, determining the exchange ratio may be configured to determine the exchange ratio using a first exchange index corresponding to the prize event and a second exchange index corresponding to the exchange target event.

Here, the first exchange index may be calculated in consideration of one or more of information about the event period of the prize event, information about the prize of the prize event, and information about utility of the prize event advertising media, and the second exchange index may be calculated in consideration of one or more of information about an event period of the exchange target event, information about a prize of the exchange target event, and information about utility of the exchange target advertising media corresponding to the exchange target event.

Here, determining the exchange ratio may be configured to monitor progress status information of events during the event period of the prize event and to update the exchange ratio based on the progress status information within the event period.

Here, determining the exchange ratio may be configured to calculate a probability of winning the prize event during the event period of the prize event and to update the exchange ratio based on the probability within the event period.

Here, determining the exchange ratio may be configured such that, when a number of participants in the prize event does not reach a preset level during the event period of the prize event, the exchange ratio is updated within the event period so as to show the prize event more frequently as the probability of winning the prize event is higher.

Here, the prize factor may be calculated based on a prize evaluation index that is calculated by dividing a value of a total prize of an event by a number of winners.

Here, the method may further include calculating an expense including one or more of a fee for exchange of the advertising media and an additional expense incurred during the exchange of the advertising media.

Here, the exchange ratio may be set to a ratio between exchange indices, a preset preference ratio, or a ratio of exchange indices modified by incorporating a preset additional expense therein.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for providing an advertising-event-authoring tool according to an embodiment of the present invention;

FIG. 2 is a block diagram that shows an example of the configuration of the apparatus for providing an advertising-event-authoring tool illustrated in FIG. 1;

FIG. 3 is a flowchart that shows a method for providing an advertising-event-authoring tool according to an embodiment of the present invention;

FIG. 4 is a flowchart that shows an example of the step of setting advertising event content illustrated in FIG. 3;

FIG. 5 is a view that shows an example of an advertising event including a mini-game in an embodiment of the present invention;

FIG. 6 is a view that shows an example of an advertising event result report page according to an embodiment of the present invention;

FIG. 7 is a view that shows an example of an advertising event type selection page according to an embodiment of the present invention;

FIGS. 8 to 13 are views that show an example of an advertising event creation page according to an embodiment of the present invention;

FIG. 14 is a view that shows an example of a prize-setting page according to an embodiment of the present invention;

FIGS. 15 to 21 are views that show an example of an advertising event page according to an embodiment of the present invention;

FIG. 22 is a view that shows an example of an advertising event list page according to an embodiment of the present invention;

FIG. 23 is a view that shows an example of an advertising event result page according to an embodiment of the present invention;

FIGS. 24 and 25 are views that show an example of an advertising event result details page according to an embodiment of the present invention;

FIG. 26 is a view that shows an example of an event status page according to an embodiment of the present invention;

FIG. 27 is a view that shows an example of an event recommendation page according to an embodiment of the present invention;

FIG. 28 is a block diagram that shows the configuration of a system for exchanging advertising media according to an embodiment of the present invention;

FIG. 29 is a block diagram that shows the configuration of the apparatus for exchanging advertising media illustrated in FIG. 28;

FIG. 30 is a flowchart that shows a method for exchanging advertising media according to an embodiment of the present invention;

FIG. 31 is a flowchart that shows an example of the step of determining an exchange target event, illustrated in FIG. 30;

FIG. 32 is a flowchart that shows an example of the step of exchanging media, illustrated in FIG. 30;

FIG. 33 is a view that shows an example of exchanging media in an embodiment of the present invention;

FIG. 34 is a view that shows an example of exchanging media in an embodiment of the present invention;

FIG. 35 is a view that shows an example of an advertising schedule arranged as a result of exchanging media in an embodiment of the present invention; and

FIG. 36 is a view that shows an example of an advertising schedule arranged as a result of exchanging media in an embodiment of the present invention.

### DESCRIPTION OF THE PREFERRED EMBODIMENTS

The present invention may be variously changed, and may have various embodiments, and specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, but all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

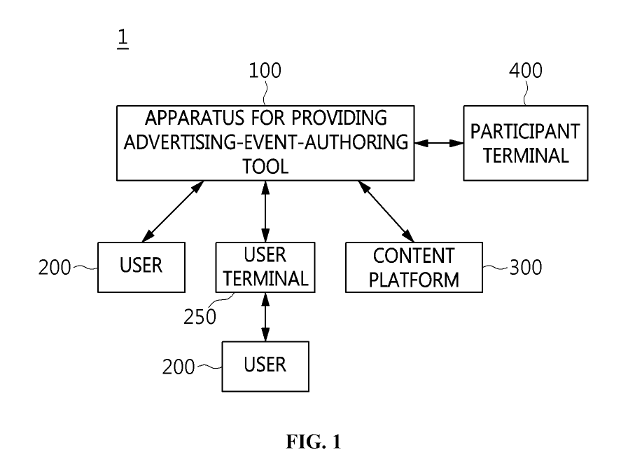

FIG. 1 is a view that shows the configuration of a system 1 for providing an advertising-event-authoring tool according to an embodiment of the present invention.

Referring to FIG. 1, in the system 1 for providing an advertising-event-authoring tool according to an embodiment of the present invention, an apparatus 100 for providing an advertising-event-authoring tool is interconnected with a user 200, a user terminal 250, a content platform 300, and a participant terminal 400.

The apparatus 100 for providing an advertising-event-authoring tool according to an embodiment of the present invention is configured to set information about the product to be advertised through an advertising event, the type of the advertising event, advertising event content, and information about rewards to be offered to participants in the advertising event depending on input from the user 200 or the user terminal 250, and to generate advertising event data depending on the set information. That is, the apparatus 100 for providing an advertising-event-authoring tool may be an apparatus for creating an advertising event, and may be an apparatus for providing an advertising event. For example, the apparatus 100 for providing an advertising-event-authoring tool may include an event database for storing generated advertising event data therein, and may provide the stored advertising event data to a device that requires an advertising event.

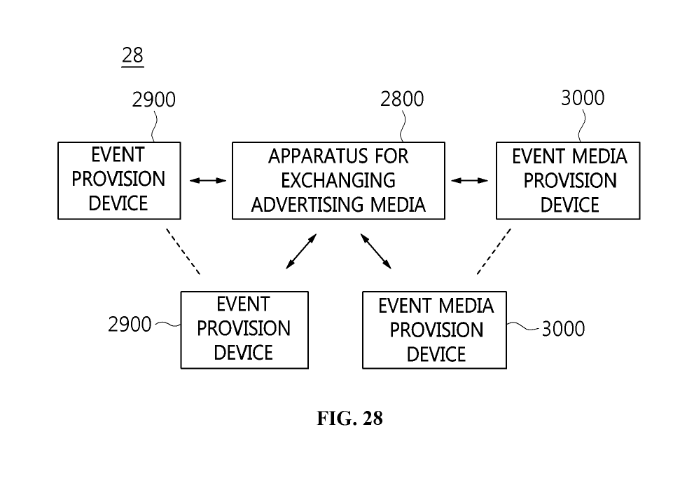

Here, when advertising event data are generated, one or more candidate events interchangeable with an advertising event or a prize event may be determined. When the exchange target event to be interchanged is determined from among the candidate events, an exchange ratio is determined. Then, based on the exchange ratio, the prize event is allocated to an exchange target advertising media corresponding to the exchange target event, whereby media may be exchanged. A detailed description thereof will be made with reference to FIGS. 28 to 36.

Here, the types of advertising events may include ‘simple entry’, ‘participation in game’, ‘participation in advertisement and game’, ‘custom event’, and a combination thereof. Also, advertising event content may include mini-games, videos, images, animations, text, and the like. Also, reward information is information in which rewards for an advertising event, criteria for offering rewards, and the like are specified. For example, when ‘participation in game’ is set as the advertising event type, reward information may specify that different rewards are offered to participants depending on their ranks, a reward is offered to a participant who is drawn from among those who scored more than a certain number of points, rewards are offered to those who are ranked at a certain place, or a reward is offered to a randomly drawn participant regardless of ranks or points.

Particularly, advertising event data may be generated so as to be provided on a webpage, and may be provided to various participant terminals 400 via mobile webpages.

Here, chances to participate in a mini-game may be limited. The chance to participate in a mini-game may be obtained after a certain time or may be purchased, or coins or tickets for buying a chance to participate in a game may be received by participating in advertisement.

Here, the apparatus 100 for providing an advertising-event-authoring tool may provide a content list of a content library to a user, and may set content selected by the user as advertising event content.

Here, the content library includes various content that can be set as advertising event content by a user 200, and the user 200 may set advertising event content merely by selecting the content in the content library. That is, the user 200 may create content and use the content as advertising event content, but may also use content included in the content library as the advertising event content.

Here, the content library of the apparatus 100 for providing an advertising-event-authoring tool may be a content platform library in the content platform 300, or may be a content platform library received from the content platform 300. When the apparatus 100 for providing an advertising-event-authoring tool receives the content platform library from the content platform 300, the received content platform library may be stored in a content library storage unit, and the stored content platform library may be used.

Here, the apparatus 100 for providing an advertising-event-authoring tool may include one or more of text, an image, sound, a video, an animation, and a mini-game as advertising event content, and may change one or more of a difficulty level, an item, a background, a character, an object, and a goal of a mini-game based on information about the product to be advertised when the advertising event content is the mini-game, thereby creating a mini-game customized to the product to be advertised.

Here, the apparatus 100 for providing an advertising-event-authoring tool may generate statistical information by collecting the results of advertising events that are progressing or completed, and may analyze the advertising results.

For example, the number of exposures, the approximate number of participants, the effective number of participants, the satisfaction of participants, participants' ages, genders and occupations, advertising costs, and the like are collected as advertising results of the created advertising event, and statistical information may be generated based thereon. Here, the number of exposures may be the number of times the advertising event is shown to users, the approximate number of participants may be the number of participants who access the advertising event page, and the effective number of participants may be the number of participants who actually enter the advertising event by accessing the advertising event page and executing the advertising event content.

Here, participant information may be information required of a participant in order to offer a reward and to analyze a result. For example, the participant information may include a name, contact information, an address, a gender, an age, an occupation and the like.

Also, the statistical information to be generated may include categories based on ages, genders, occupations, and the like of participants, and may include the effective number of participants, the satisfaction of participants, the re-participation rate of participants, and the like for each category.

Here, using the statistical information, the apparatus 100 for providing an advertising-event-authoring tool may generate a report on the results of advertising events.

Here, the report includes the results of advertising events corresponding to the set advertising event type or statistical information thereabout, and the information included in the report may be categorized depending on report categorization conditions.

Here, the apparatus 100 for providing an advertising-event-authoring tool may analyze the correlation of advertising results with one or more of the kind of product to be advertised, the advertising event type, the advertising event content, and the reward information.

That is, the kind of product to be advertised and the advertising event type are grouped, and the correlation thereof with the advertising result may be analyzed, or the kind of product to be advertised, the advertising event type, and the advertising event content are grouped, and the correlation thereof with the advertising result may be analyzed.

For example, when the product to be advertised is sneakers, if setting an advertising event type to ‘participation in game’ brings a better advertising result or effect than when ‘simple entry’ is set as the advertising event type, this may be analyzed as the correlation between an advertising event type and an advertising result. Also, when the product to be advertised is sneakers and when an advertising event type is set to ‘participation in game’, if selecting a mini-game in which a character wearing the sneakers is running as the advertising event content brings a better advertising result or effect than when a mini-game irrelevant to the product is selected as the advertising event content, this may be analyzed as the correlation between advertising event content and an advertising result. Also, the correlation between a reward and an advertising result may be analyzed.

Here, using the analyzed correlation, the apparatus 100 for providing an advertising-event-authoring tool may select one or more of a recommended advertising event type, recommended advertising event content, and recommend reward information suitable for the product to be advertised.

For example, when the product to be advertised is sneakers, if the provision of an advergame in which a character wearing the sneakers is running brought a good advertising result, an advergame may be selected as a recommended advertising event type when the product to be advertised is sneakers. Also, when the product to be advertised is sneakers, a mini-game in which a character wearing the sneakers is running may be selected as recommended advertising event content. Also, when the product to be advertised is sneakers, a gift certificate for sneakers may be selected as recommended reward information. Here, advergame may refers a game for an advertisement.

Here, if there is a recommended advertising event type corresponding to the product to be advertised, the apparatus 100 for providing an advertising-event-authoring tool may recommend the advertising event type. Also, if there is recommended advertising event content corresponding to the product to be advertised, the apparatus 100 for providing an advertising-event-authoring tool may recommend the advertising event content. Also, if there is recommended reward information corresponding to the product to be advertised, the apparatus 100 for providing an advertising-event-authoring tool may recommend the reward information.

For example, when the product to be advertised is sneakers, an advergame may be recommended as an advertising event type. Also, when the product to be advertised is sneakers, a mini-game in which a character wearing the sneakers is running may be recommended as advertising event content. Also, when the product to be advertised is sneakers, a gift certificate for sneakers may be recommended as a reward.

Here, the apparatus 100 for providing an advertising-event-authoring tool may use methods such as ‘simple recommendation’, ‘recommendation for each item’, ‘recommendation for each business type’, ‘recommendation based on data’, and the like. Specifically, ‘simple recommendation’ is a method in which advertising events that brought good advertising results or effects may be recommended based on conditions, such as an event type, the budget for an event, and the like. Also, ‘recommendation for each item’ is a method in which advertising events that brought good advertising results or effects may be recommended based on conditions such as genders, ages, and occupations of customers, seasons, regions, countries, races, and the like. Also, ‘recommendation for each business type’ is a method in which advertising events that brought good advertising results or effects may be recommended depending on conditions such as the type of business in which an advertiser is engaged, the type of medium, and the like. Also, ‘recommendation based on data’ is a method in which advertising events that brought good advertising results or effects may be recommended depending on conditions such as games, prizes (rewards), methods for drawing a winner, and the like. Also, detailed index items for recommending an advertising event may include the response of participants, advertising effects, and the like depending on participants' genders and ages, the day of the week, the month, and the time of day when the participants enter an advertising event, and the like.

Here, when the advertising event type is set, the apparatus 100 for providing an advertising-event-authoring tool may provide an advertising-event-authoring template corresponding to the advertising event type.

For example, when the advertising event type is set to mini-game advertisement, a list of content for configuring a mini-game is provided from a content library, and a user selects content in the list, whereby advertising event content may be set. Also, when the advertising event type is set to video advertisement, an upload interface for selecting a video, an interface for inputting the address of a video, and the like are provided, and the user may set advertising event content by uploading a video or inputting the address of a video using the provided interface.

That is, the user 200 may easily create an advertising event using an advertising-event-authoring template.

Here, the apparatus 100 for providing an advertising-event-authoring tool may provide a preview screen for the advertising event based on the set information. For example, when a user 200 sets a mini-game in which a character wearing the product to be advertised is running as the advertising event content, the advertising event preview screen may display the mini-game in which a character wearing the product to be advertised is running. Also, the user 200 may check how the mini-game is displayed when a participant participates in the corresponding advertising event.

Here, the apparatus 100 for providing an advertising-event-authoring tool may calculate the advertising cost to be charged for an advertising event service used by the user 200. Particularly, a pricing method may be implemented such that a reward replaces the advertising costs. For example, membership points, electronic money, gift certificates, and the like corresponding to the advertising costs may be used as payment for the advertising costs.

Also, the advertising costs may be automatically calculated by calculating a weighted sum in consideration of the number of exposures of an advertising event, the number of exposures of advertising event content, the length of time during which the advertising event is shown, the length of time during which the advertising event content is shown, the approximate number of participants, the effective number of participants, the number of times a chance to participate in a game is purchased, and the like. Also, different advertising costs may be set depending on windows of time throughout the day in which the advertising event is shown. For example, commuting hours, weekend evenings, and the like are set as peak times, and an extra cost may be applied thereto.

Also, advertising costs are calculated in consideration of variation in past advertising costs, variation in the number of participants in the past, the characteristics of the business type, and the like. Here, a standard price is set in consideration of variation in past advertising costs, variation in the number of participants in the past, the characteristics of the business type, and the like, and the final price is determined through a bid, whereby the advertising event of a successful bidder may be shown at the desired time.

A user 200 may create an advertising event by controlling the apparatus 100 for providing an advertising-event-authoring tool through the user terminal 250.

The user terminal 250 is a terminal that the user 200 uses in order to control the apparatus 100 for providing an advertising-event-authoring tool. Here, the user terminal 250 may be various types of terminals having input/output functions, calculation functions and the like, for example, a laptop, a desktop computer, a smartphone, a tablet PC, or the like.

The content platform 300 includes various content that can be used as advertising event content. Here, the various content may include mini-games, videos, images, and the like.

Here, content is created in the form of an application, or is created so as to be run in an internet browser without installing a special application, and may be created using various programming languages. Also, content may be created using a language with high compatibility such that the content is capable of being run on various kinds of participant terminals 400. For example, content may be created using Hyper-Text Markup Language 5 (HTML5).

Here, content in the content platform 300 may be content that is created for an advertising event and configured such that information related to the product to be advertised may be added therein. For example, the shoes worn by a character in the content may be displayed as the sneakers to be advertised, or an item available in the content may be set to the image of the product to be advertised. Also, the content may be produced as an advergame in which the product to be advertised is shown.

Here, the content platform 300 may be configured to be separate from the apparatus 100 for providing an advertising-event-authoring tool, as shown in FIG. 1, but may be included in the apparatus 100 for providing an advertising-event-authoring tool.

Here, the content platform 300 may be an application store or game store platform. That is, content producers provide content produced by themselves to others, either for payment or at no cost, by registering the content in the content platform 300, and the present invention may be implemented such that a user 200 selects content from the content platform library of the content platform 300, uses the selected content, and pays for the use of the content. That is, when the content registered in the content platform 300 is paid content, the user may use the corresponding content after paying for the same, but when the registered content is free content, the user may use the corresponding content without paying.

The participant terminal 400 is a terminal that a participant uses in order to participate in an advertising event created in the apparatus 100 for providing an advertising-event-authoring tool. Here, the participant terminal 400 may be various types of terminals having input/output functions, calculation functions and the like, for example, a laptop, a desktop computer, a smartphone, a tablet PC, or the like.

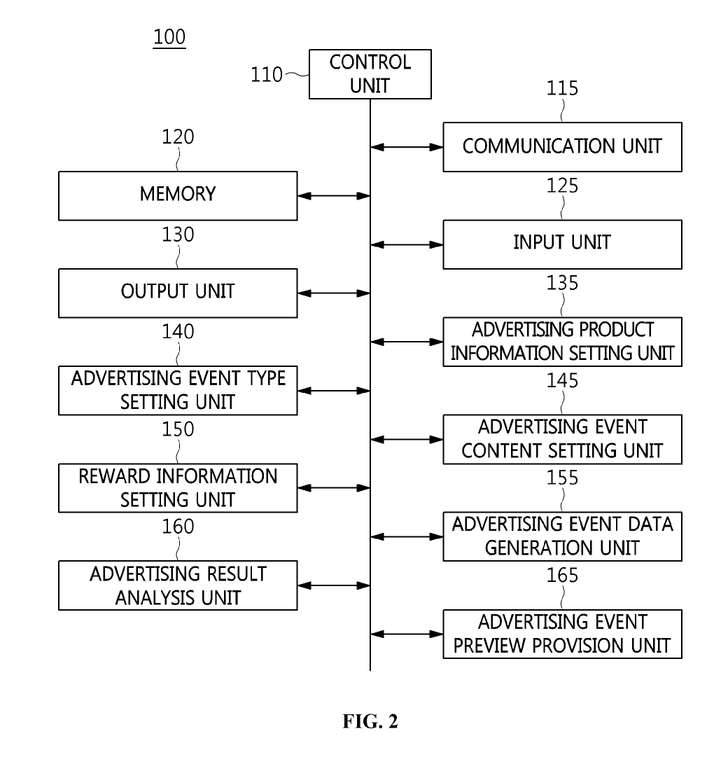

FIG. 2 is a block diagram that shows an example of the configuration of the apparatus 100 for providing an advertising-event-authoring tool, illustrated in FIG. 1.

Referring to FIG. 2, the apparatus 100 for providing an advertising-event-authoring tool according to an embodiment of the present invention includes a control unit 110, a communication unit 115, memory 120, an input unit 125, an output unit 130, an advertising product information setting unit 135, an advertising event type setting unit 140, an advertising event content setting unit 145, a reward information setting unit 150, an advertising event data generation unit 155, an advertising result analysis unit 160, an advertising event preview provision unit 165, and the like.

Specifically, the control unit 110 is a kind of central processing unit, and controls the overall process for providing an advertising-event-authoring tool. That is, the control unit 110 may provide various functions by controlling the communication unit 115, the memory 120, the input unit 125, the output unit 130, the advertising product information setting unit 135, the advertising event type setting unit 140, the advertising event content setting unit 145, the reward information setting unit 150, the advertising event data generation unit 155, the advertising result analysis unit 160, the advertising event preview provision unit 165, and the like.

Here, the control unit 110 may include all kinds of devices capable of processing data, such as a processor and the like. Here, a ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 115 provides a communication interface that is necessary in order to send or receive signals to or from the user terminal (250 in FIG. 1), the content platform (300 in FIG. 1), and the participant terminal (400 in FIG. 1).

Here, the communication unit 115 may be a device including hardware and software that are necessary in order to send and receive signals, such as control signals or data signals, through a wired or wireless connection with another network device.

Here, the communication unit 115 may create an advertising event by sending and receiving control signals or data signals to and from the user terminal (250 in FIG. 1), and may send information about the progress of the creation of an advertising event, the created advertising event data (or an advertising event campaign), and the like to the user terminal (250 in FIG. 1).

The memory 120 functions to temporarily or permanently store data processed by the control unit 110. Here, the memory 120 may include magnetic storage media or flash storage media, but the present invention is not limited thereto.

The input unit 125 is a device for receiving a control signal for creating an advertising event from the user (200 in FIG. 1). Here, the input unit 125 may include a keyboard, a mouse, a touchpad, a touch panel, and the like.

The output unit 130 outputs information about the progress of the creation of an advertising event, the created advertising event data, and the like when the advertising event is created through the input unit 125. Here, the output unit 130 may include a display device for outputting visual information, a speaker device for outputting sound information, and the like.

The advertising product information setting unit 135 sets information about the product to be advertised, that is, the target of an advertising event to be created.

Here, information about the product to be advertised includes a product name, a product type or a category in which the product is included, a manufacturer, a price, a release date, information about product specifications and product functions, a method of using the product, and the like.

The advertising event type setting unit 140 may set an event type for providing an advertising event.

Here, the advertising event type includes ‘simple entry’, ‘participation in game’, ‘participation in advertisement and game’, ‘custom event’, and a combination thereof.

Specifically, ‘simple entry’ represents an event that a participant may enter after checking the content of the event, and may be useful when only an information page is required to be provided. ‘Participation in game’ represents an event configured such that a chance to enter the event is given to those who participate in a game, and may be useful when a user intends to use a game that provides enjoyment in order to entice participants to enter the event. ‘Participation in advertisement and game’ represents an event configured such that a chance to enter the event is given to those who view a certain advertisement and participate in a game. ‘Custom event’ represents an event configured such that a user can create an event page by himself or herself after writing a brief description of the event, and may be designed using Application Programming Interfaces (APIs) and the like, without limitation as to the format thereof

Here, the advertising event type setting unit 140 may provide an advertising-event-authoring template corresponding to the set advertising event type.

Here, when there is a recommended advertising event type, which is selected based on the advertising result analyzed by the advertising result analysis unit 160, the advertising event type setting unit 140 may recommend the advertising event type.

The advertising event content setting unit 145 sets advertising event content that is to be included in the advertising event.

Here, the advertising event content includes a brief description of the advertising event, information about the product to be advertised, a component that can be executed by participants as the advertising event, and the like, and may be configured with a mini-game, a video, an image, an animation, sound, text, and the like.

That is, when the advertising event content is set to text, an image, sound, a video, an animation, or the like, it functions to unilaterally deliver information, but when the advertising event is set to a mini-game, not only may information be delivered but active participation may also be encouraged through the interaction with participants, and participants' attention may be attracted.

When a mini-game is set as the advertising event content, the content may include information in which the time at which a chance to play a game is to be provided, the number of chances, the number of products to be used for the game and the discount rate of the products, the game to be provided, and the like are specified.

Particularly, the user (200 in FIG. 1) may select a game that is ideal for the product to be advertised. There is no limitation as to the type of game that can be selected, and a game for randomly drawing a winner, a competitive game for testing memory, and the like may be included. Also, a suitable mini-game may be selected in consideration of the image or characteristics of the product to be advertised.

Here, the advertising event content setting unit 145 may change one or more of the difficulty level, the item, the background, the character, the object, and the goal of a mini-game depending on information about the product to be advertised.

For example, when the product to be advertised is sneakers and a mini-game in which a character runs as far as possible within a limited time is selected, the character of the mini-game may be changed to the image of the celebrity model of the corresponding product, the background may be changed to a playground or a stadium, the sneakers to be advertised may be provided as an item for improving performance in the game, or the goal of the game may be changed to making the character run a set distance as fast as possible, that is, the mini-game may be customized for the product to be advertised.

Here, the advertising event content setting unit 145 provides a content list of the content library, and may set the content selected by the user (200 in FIG. 1) as the advertising event content.

Here, the content library may include various content, which may be set as advertising event content by the user (200 in FIG. 1), and the user (200 in FIG. 1) may set advertising event content merely by selecting the content in the content library. That is, the user (200 in FIG. 1) may create content and use the content as advertising event content, but may alternatively use content included in the content library as the advertising event content.

Here, the content library may be a content platform library in the content platform (300 in FIG. 1), or may be a content platform library received from the content platform (300 in FIG. 1). When the apparatus 100 for providing an advertising-event-authoring tool receives the content platform library from the content platform (300 in FIG. 1), the received content library platform may be stored in a content library storage unit, and the stored content platform library may be used.

Here, when there is recommend advertising event content, which is selected based on the advertising result analyzed by the advertising result analysis unit 160, the advertising event content setting unit 145 may recommend the advertising event content.

The reward information setting unit 150 sets information about rewards to be offered to participants in the advertising event.

Here, the reward information is information in which rewards for an advertising event, criteria for offering rewards, and the like are specified. That is, the type of rewards, the number of rewards, products to be offered as rewards, and the like for an advertising event may be included.

For example, the criterion for offering a reward may be set so as to offer rewards to the participants in a mini-game depending on their ranks, to offer a reward to a person who is ranked at a certain place, among the participants in the mini-game, to offer a reward to a person randomly drawn from among the participants in the mini-game regardless of the ranks or points, or to offer a reward to a person randomly drawn from among the participants who scored more than a certain number of points in the mini-game. Also, levels may be set depending on points earned in the mini-game, different rewards may be set for the respective levels, and a reward may be offered to one selected from each level.

Here, the reward may be the product to be advertised, a gift certificate for a certain product other than the product to be advertised, a discount coupon, or the like, and may be provided in the form of a mobile voucher, membership points, a gift certificate printed on paper, and the like.

Here, in order to offer a reward, a shopping-mall platform may be connected with the apparatus for providing an advertising-event-authoring tool. That is, a reward may be provided in the form of a gift certificate, a discount coupon, points, and the like available for products registered in the shopping-mall platform. Accordingly, the participant in the advertising event may easily receive the reward for the advertising event using the gift certificate, the discount coupon, or the points offered as the rewards in the corresponding shopping-mall platform.

Here, the shopping-mall platform may be a platform that may function as an online shopping mall. Therefore, the shopping-mall platform may provide functions related to products, such as exhibition, display, management, and the like of products. Also, the shopping-mall platform may provide functions related to members, such as customer management, customer points management, member information management, and the like. Also, the shopping-mall platform may provide functions related to shopping mall services, such as orders, shopping list management, delivery, payments, and the like.

Here, using a customer survey function, the reward information setting unit 150 may provide additional information in order to help a user select a more advantageous reward. For example, the user (200 in FIG. 1) may check participants' preferences for products to be offered as rewards by giving participants a limited number of chances to enter advertising events and making the participants selectively participate in advertising events that provide different rewards, and may then set reward information based on the participants' preferences.

Here, when there is recommended reward information, which is selected based on the advertising result analyzed by the advertising result analysis unit 160, the reward information setting unit 150 may recommend the reward information.

Here, the reward information setting unit 150 may set a reward receiving period, and may cancel any reward that has not been received when the reward receiving period expires.

The advertising event data generation unit 155 generates advertising event data depending on the set information, such as information about the product to be advertised in the advertising event, the advertising event type, the advertising event content, the reward information, and the like. In this specification, the advertising event data and an advertising event campaign may be used interchangeably with each other.

Here, the advertising event data generation unit 155 may generate advertising event data so as to be provided on a webpage or a mobile webpage. That is, advertising event data may be generated such that, even when advertising event content includes a mini-game, the content may be run on the webpage without installing a special application.

The advertising result analysis unit 160 generates statistical information by collecting advertising results of the completed advertising events and advertising results of the advertising events that have been created and are progressing, and analyzes the advertising results based on the statistical information.

Here, the advertising result analysis unit 160 may generate statistical information using the number of advertising exposures, the approximate number of participants, the effective number of participants, the satisfaction of participants, participants' ages, genders and occupations, advertising costs, and the like.

Here, participant information may be information required of a participant in order to offer a reward and to analyze a result. For example, the participant information may include a name, contact information, an address, a gender, the birth date, an age, an occupation, and the like.

Also, the statistical information to be generated may include categories corresponding to ages, genders, occupations, and the like of participants, and may include the percentage of the effective participants, the satisfaction of participants, the re-participation rate of participants, and the like for each category.

Here, the advertising result analysis unit 160 may generate a report on the results of advertising events using the statistical information.

Here, the report includes the results of advertising events corresponding to the set advertising event type or statistical information thereabout, and the information included in the report may be categorized depending on report categorization conditions.

Here, the advertising result analysis unit 160 may analyze the correlation of advertising results with one or more of the kind of product to be advertised, the advertising event type, the advertising event content, and the reward information. That is, the kind of product to be advertised and the advertising event type are grouped, and the correlation thereof with the advertising result may be analyzed, or the kind of product to be advertised, the advertising event type, the advertising event content, and the reward information are grouped, and the correlation thereof with the advertising result may be analyzed.

Here, using the analyzed correlation, the advertising result analysis unit 160 may select one or more of a recommended advertising event type, recommended advertising event content, and recommended reward information suitable for the product to be advertised.

The advertising event preview provision unit 165 provides the preview screen for the advertising event based on the set information. That is, the screen to be displayed when the advertising event data, which are to be generated by the advertising event data generation unit 155, are provided to the participant terminal (400 in FIG. 1) may be provide as a preview screen.

Here, the preview screen for an advertising event may be displayed via the output unit 130. Also, the preview screen for the advertising event may be sent to the user terminal (250 in FIG. 1) via the communication unit 115, and may be displayed in the user terminal (250 in FIG. 1).

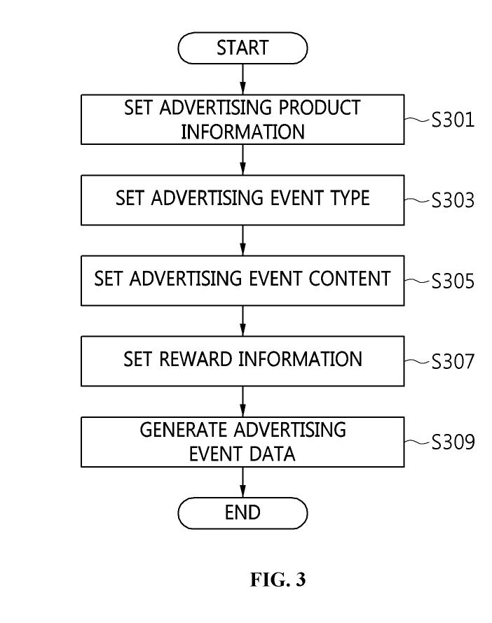

FIG. 3 is a flowchart that shows a method for providing an advertising-event-authoring tool according to an embodiment of the present invention.

Referring to FIG. 3, in the method for providing an advertising-event-authoring tool according to an embodiment of the present invention, the apparatus (100 in FIG. 1) for providing an advertising-event-authoring tool sets information about the product to be advertised through an advertising event at step S301.

Here, information about the product to be advertised may include a product name, the type of product or category in which the product is included, the manufacturer, the price, the release date, information about product specifications and functions, the method of using the product, and the like.

Also, in the method for providing an advertising-event-authoring tool according to an embodiment of the present invention, the apparatus (100 in FIG. 1) for providing an advertising-event-authoring tool sets an advertising event type at step S303.

Here, the advertising event type includes ‘simple entry’, ‘participation in game, ‘participation in advertisement and game’, ‘custom event’, and a combination thereof.

Also, in the method for providing an advertising-event-authoring tool according to an embodiment of the present invention, the apparatus (100 in FIG. 1) for providing an advertising-event-authoring tool sets advertising event content that is to be included in the advertising event at step S305.

Here, the advertising event content includes a brief description of the advertising event, information about the product to be advertised, a component that can be executed by participants as the advertising event, and the like, and may be configured with a mini-game, a video, an image, an animation, sound, text, and the like.

Also, in the method for providing an advertising-event-authoring tool according to an embodiment of the present invention, the apparatus (100 in FIG. 1) for providing an advertising-event-authoring tool sets information about rewards for participation in the advertising event at step S307.

Here, the reward information may be information in which rewards for advertising events, criteria for offering rewards, and the like are specified. That is, the reward information may include the type of rewards, the number of rewards, information about products to be offered as rewards, and the like for the advertising event.

Also, in the method for providing an advertising-event-authoring tool according to an embodiment of the present invention, the apparatus (100 in FIG. 1) for providing an advertising-event-authoring tool generates advertising event data at step S309 depending on the set information, such as information about the product to be advertised in the advertising event, the advertising event type, the advertising event content, the reward information, and the like.

Here, the advertising event data may be generated so as to be provided from a webpage, and may be generated so as to support a mobile webpage.

In an alternative embodiment, among the above steps S301, S303, S305, S307 and S309, setting an advertising event type at step S303 may be performed before setting information about the product to be advertised at step S301.

In an alternative embodiment, among the above steps S301, S303, S305, S307 and S309, setting reward information at step S307 may be performed before setting advertising event content at step S305.

In an alternative embodiment, among the above steps S301, S303, S305, S307 and S309, setting an advertising event type at step S303, setting advertising event content at step S305, and setting information about the product to be advertised at step S301 may be performed in the order in which the steps are listed.

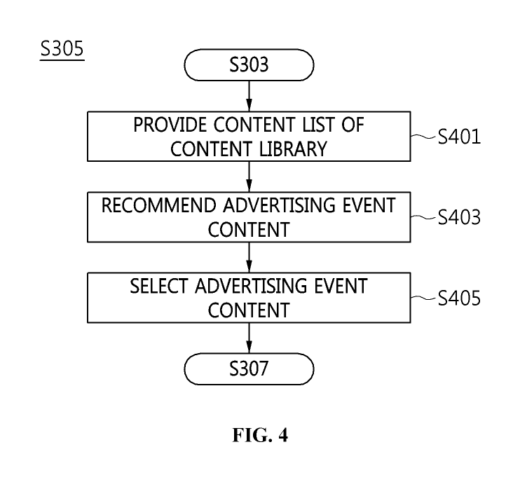

FIG. 4 is a flowchart that shows an example of the step (S305) of setting adverting event content, illustrated in FIG. 3.

Referring to FIG. 4, in the step (S305) of setting advertising event content illustrated in FIG. 3, the apparatus (100 in FIG. 1) for providing an advertising-event-authoring tool provides a content list of a content library at step S401.

Here, the content library includes various content that can be set as advertising event content by the user (200 in FIG. 1).

Here, the content library may be the content platform library in the content platform (300 in FIG. 1), or may be the content platform library received from the content platform (300 in FIG. 1). When the apparatus (100 in FIG. 1) for providing an advertising-event-authoring tool receives the content platform library from the content platform (300 in FIG. 1), the received content platform library may be stored in a content library storage unit, and the stored content platform library may be used.

Also, in the step (S305) of setting advertising event content illustrated in FIG. 3, when there is recommended advertising event content, the apparatus (100 in FIG. 1) for providing an advertising-event-authoring tool recommends the advertising event content at step S403.

Here, the recommended advertising event content may be advertising event content expected to bring a good advertising result or effect because the results of analysis of the advertising results of running or completed advertisements satisfy preset criteria.

Also, in the step (S305) of setting advertising event content illustrated in FIG. 3, the apparatus (100 in FIG. 1) for providing an advertising-event-authoring tool selects advertising event content at step S405.

Here, the user (200 in FIG. 1) may set content as advertising event content merely by selecting the content from the content list. That is, the user (200 in FIG. 1) may produce content and use the same as advertising event content, but may alternatively use content included in the content library as the advertising event content.

In an alternative embodiment, among the above steps S401, S403 and S405, providing a content list at step S401 and recommending advertising event content at step S403 may be performed in parallel.

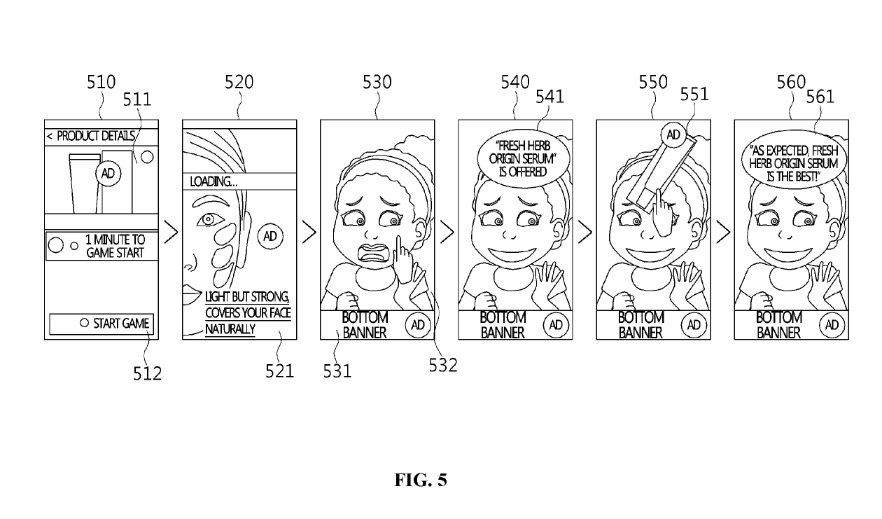

FIG. 5 is a view that shows an example of an advertising event including a mini-game in an embodiment of the present invention.

Referring to FIG. 5, in an embodiment of the present invention, the advertising event including a mini-game includes an advertising event participation page 510. The advertising event participation page may include information 511 about a product to be advertised, information on how to participate in an advertising event, a button 512 for participating in an advertising event, and the like.

Also, in an embodiment of the present invention, when a participant participates in the advertising event, a content-loading page 520, including information 521 about the product to be advertised, is shown in the advertising event including a mini-game.

Also, in an embodiment of the present invention, the advertising event including a mini-game includes advertising event content pages 530, 540, 550 and 560 that provide the mini-game 532. Here, each of the advertising event content pages 530, 540, 550 and 560 may include an advertisement in the form of a banner 531 at the bottom thereof

For example, the mini-game 532 illustrated in FIG. 5 is a mini-game, the goal of which is to wash the face of a character within a preset time by clicking or touching pimples, acne, and the like. In the mini-game, when the number of touches becomes equal to or greater than a preset value, an item imitative of the advertised product may be offered 541, so that a player may be encouraged to actively participate in the mini-game using the offered item 551 corresponding to the advertised product. Also, when the player finishes the mini-game using the offered item 551, a message 561 for promoting the advertised product may be displayed.

That is, the advertised product may be continuously promoted using the banner 531 at the bottom of a page, but the advertised product may be more effectively promoted by implying that the use of the item 551 corresponding to the advertised product produces a good effect in the mini-game 532.

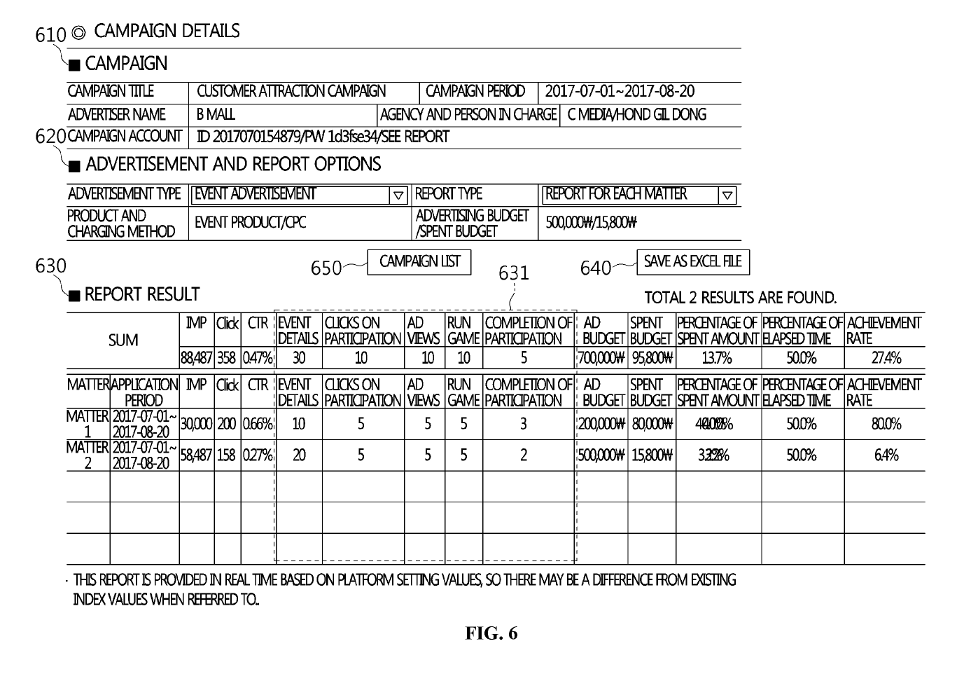

FIG. 6 is a view that shows an example of an advertising event result report page according to an embodiment of the present invention.

Referring to FIG. 6, the advertising event result report page according to an embodiment of the present invention includes summary information 610 about an advertising event campaign, advertisement and report type selection information 620, a result 630, and the like.

Specifically, the summary information 610 about an advertising event campaign may include an advertising event name or a campaign title, a period, the name of a user or an advertiser, an agency, a person in charge, account information, and the like. Also, the advertisement and report type selection information 620 may include information about selectable advertisement types, information about selectable report conditions, product type and charging information, advertising cost information, and the like. Also, in the result 630, an advertisement result report corresponding to the options selected in the advertisement and report type selection information 620 may be displayed in the form of an itemized list. Here, when the product type is an event, additional indices 631 may be provided.

Also, the advertising event result report page according to an embodiment of the present invention may include a button 640 for downloading the advertising result report and saving the same as an Excel or spreadsheet data file.

Also, the advertising event result report page according to an embodiment of the present invention may include a campaign list button 650 for moving to a campaign list page.

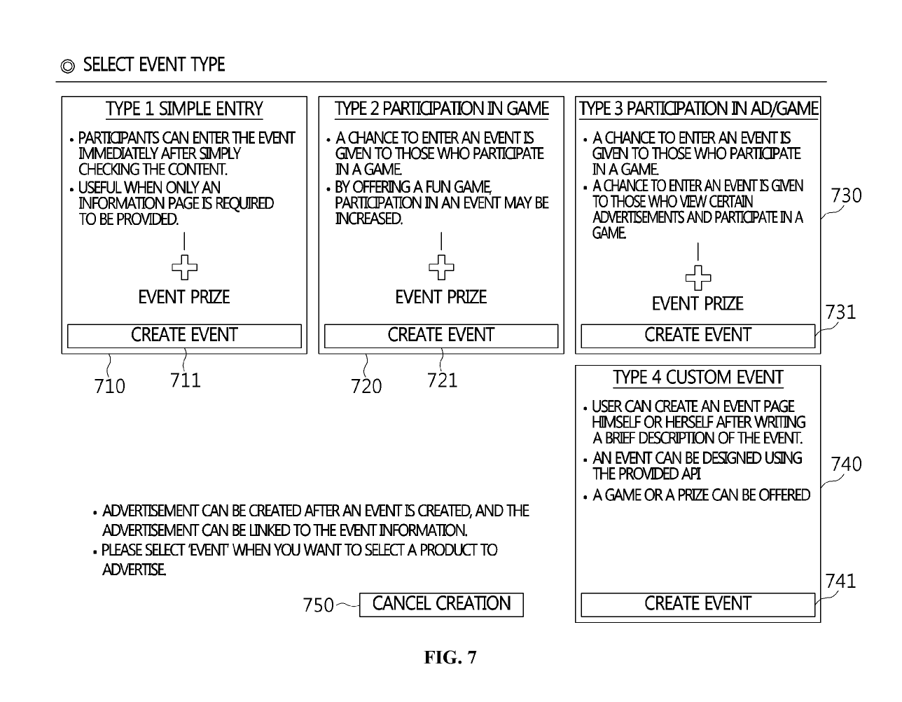

FIG. 7 is a view that shows an example of an advertising event type selection page according to an embodiment of the present invention.

Referring to FIG. 7, the advertising event type selection page according to an embodiment of the present invention may include ‘simple entry’ 710, ‘participation in game’ 720, ‘participation in advertisement and game’ 730, ‘custom event’ 740, and the like as a selectable advertising event type.

Specifically, ‘simple entry’ 710 represents an advertising event that a participant may enter immediately after checking the content thereof, and may be useful when only an information page is required to be provided. In order to select ‘simple entry’ 710 as the advertising event type, the ‘create event’ button 711 may be used.

‘Participation in game’ 720 represents an advertising event configured such that a chance to enter the event is given to those who participate in a mini-game, and may be useful when a user intends to use a game that provides enjoyment in order to entice participants to enter the event. In order to select ‘participation in game’ 720 as the advertising event type, the ‘create event’ button 721 may be used.

‘Participation in advertisement and game’ 730 represents an advertising event configured such that a chance to enter an event is given to those who view a certain advertisement and participate in a game. In order to select ‘participation in advertisement and game’ 730 as the advertising event type, the ‘create event’ button 731 may be used.

‘Custom event’ 740 represents an advertising event configured such that a user can create an event page by himself or herself after writing a brief description of the event, and may be designed using Application Programming Interfaces (APIs) and the like, without limitation as to the format thereof. In order to select ‘custom event’ 740 as the advertising event type, the ‘create event’ button 741 may be used.

Also, the advertising event type selection page according to an embodiment of the present invention may include the ‘cancel creation’ button 750 for canceling the creation of an advertising event, and the creation of an advertising event may be canceled by clicking the ‘cancel creation’ button 750.

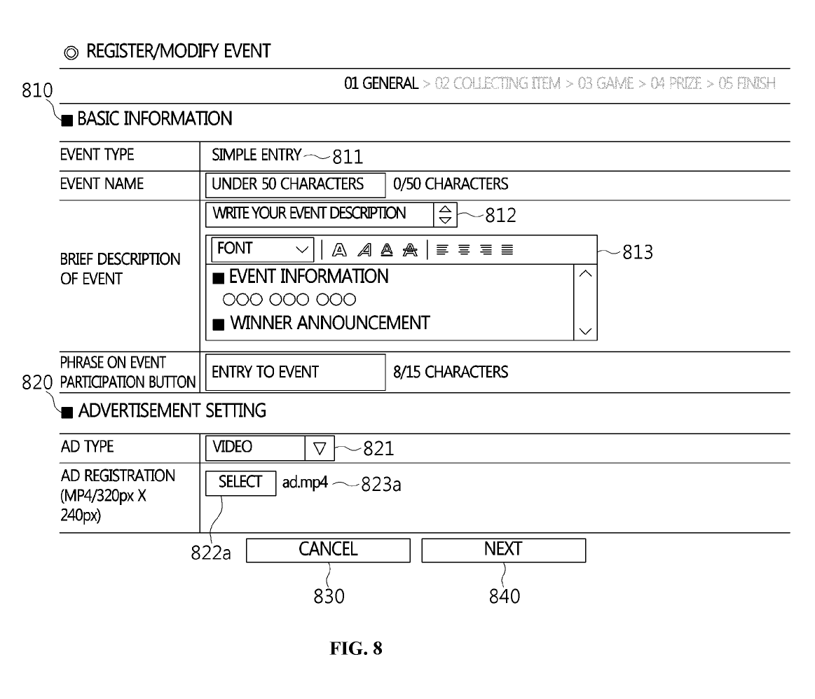

FIGS. 8 to 13 are views that show an example of an advertising event creation page according to an embodiment of the present invention.

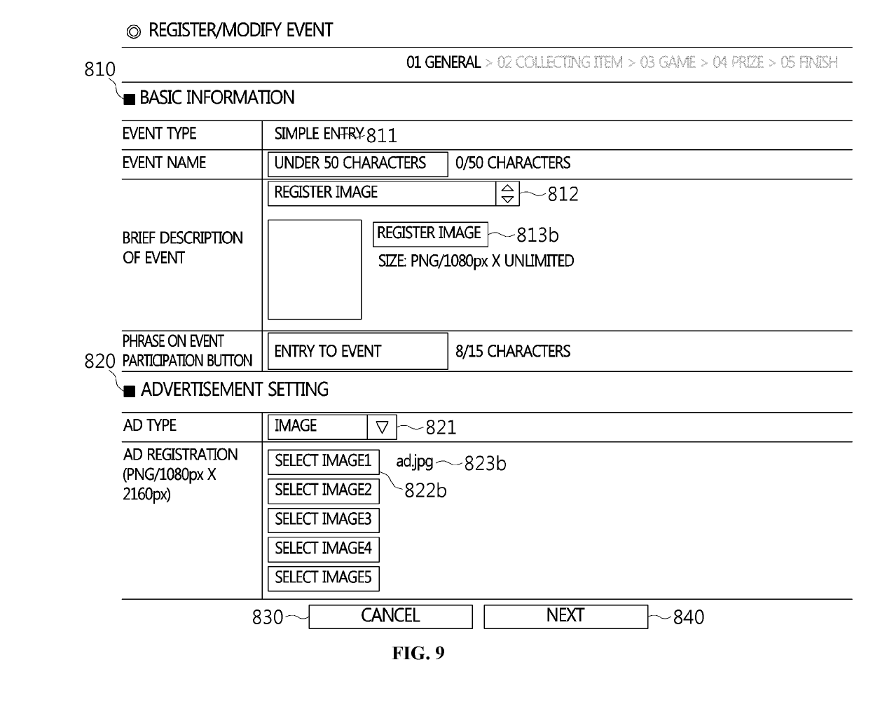

FIG. 8 and FIG. 9 show an advertising event creation page for configuring basic information 810 of an advertising event and advertisement settings 820.

In an embodiment, after one of the advertising event types illustrated in FIG. 7 is selected, the advertising event creation page shown in FIG. 8 and FIG. 9 may be displayed.

Specifically, the basic information 810 of an advertising event may include an advertising event type 811, options 812 for selecting the method of writing a brief description of the advertising event, editable text fields 813a and 813b for writing the brief description of the advertising event, and the like, and the advertisement settings 820 may include an advertisement type 821, buttons 822a and 822b for registering an advertisement, information 823a and 823b about the registered advertisement, and the like.

Here, the options 812 for selecting the method of writing a brief description of an advertising event may include ‘write your event description’, ‘register image’, and the like, and ‘write your event description’ may be the default option. The advertisement type 821 may include ‘image’, ‘video’, and the like.

For example, in FIG. 8, the advertising event type set to ‘simple entry’ is displayed, the editable text field 813a for writing an advertising event description is displayed because ‘write your event description’ is selected from the options 812 for selecting the method of writing a brief description of an advertising event, the advertisement type 821 set to ‘video’ is displayed, the button 822a for selecting a video advertisement is displayed, and advertisement information 823a indicating that encoding is progressing after the registration of the advertisement or indicating the completion of encoding is displayed.

Meanwhile, in FIG. 9, a button 813b for registering an advertising event description image is displayed because ‘register image’ is selected from the options 812 for selecting the method of writing a brief description of an advertising event, the advertisement type 821 set to ‘image’ is displayed, the button 822b for selecting an image advertisement is displayed, and advertisement information 823b indicating that encoding is progressing after the registration of the advertisement or indicating the completion of encoding is displayed.

Also, the creation of the advertising event may be canceled by clicking the ‘cancel’ button 830, or the step of creating the advertising event may be continued by clicking the ‘next’ button 840. Here, the ‘next’ button 840 is disabled by default, but may be enabled when all of the required information is input.

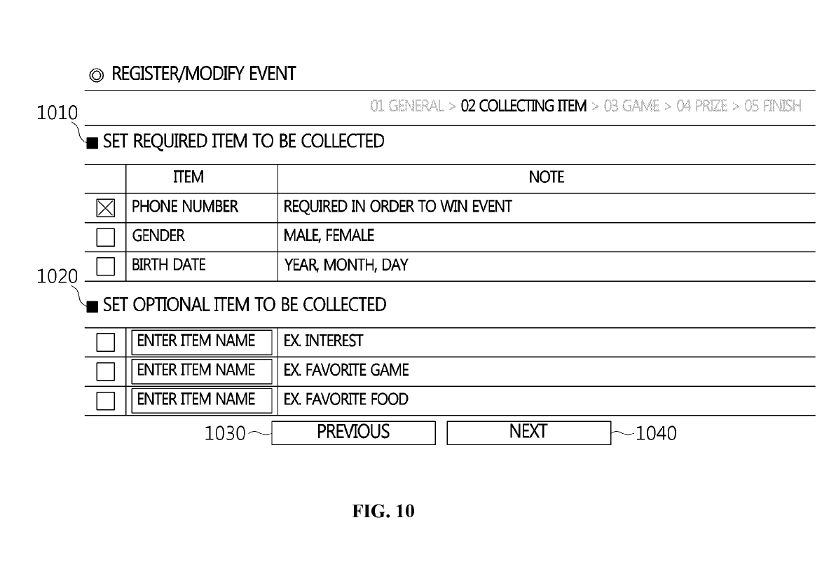

FIG. 10 is an advertising event creation page for setting required items 1010 and optional items 1020 to be collected as information about participants in an advertising event.

In an embodiment, the advertising event creation page illustrated in FIG. 10 may be displayed as the next step of the advertising event creation page illustrated in FIG. 8 or 9.

Here, the required items 1010 to be collected may include a cell phone number, a gender, the birth date, and the like, and the optional items 1020 to be collected may include an occupation, a matter of interest, a favorite game, favorite food, an income level, and the like depending on the selection of the user (200 in FIG. 1). Here, the cell phone number may be included in the required items 1010 by default.

Also, the page may move back to the step of setting the basic information of an advertising event, illustrated in FIG. 8 or 9, by clicking the ‘previous’ button 1030, or the step of creating the advertising event may be continued by clicking the ‘next’ button 1040. Here, the ‘next’ button 1040 is enabled by default, but is switched to a disabled state when an optional item 1020 is selected, and may then be enabled when information is input in the selected optional item.

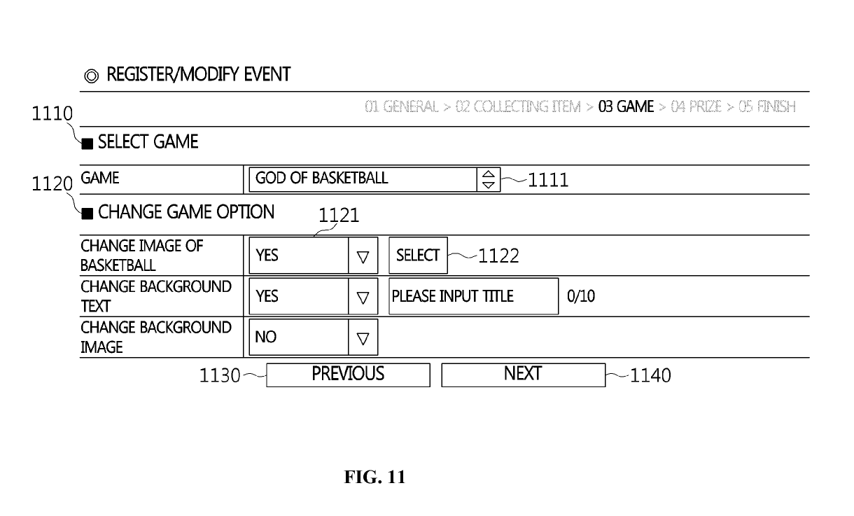

FIG. 11 is an advertising event creation page for selecting a game 1110 and setting game options 1120 when the advertising event includes a game.

In an embodiment, the advertising event creation page illustrated in FIG. 11 may be displayed as the next step of the advertising event creation page illustrated in FIG. 10.

Here, the advertising event creation page illustrated in FIG. 11 may be displayed when the advertising event type is ‘participation in game’ or ‘participation in advertisement and game’, that is, when the selected advertising event type includes a game as the advertising event content. If the selected advertising event type does not include a game as the advertising event content, the advertising event creation page shown in FIG. 11 may not be displayed.

Here, in order to enable the user to select a game 1110, a list box 1111 for selecting a game is included. Here, when the options of the selected game can be changed, items for setting game options 1120 may be displayed. For example, when a ‘basketball’ game is selected and when the options thereof can be changed, a user may decide whether to change the basketball image 1121. Also, when the user decides to change the basketball image, the user may select the image to replace the existing basketball image by clicking the ‘select’ button 1122. Here, the option 1121 for deciding whether to change an image may be set to ‘no’ by default.

Here, the list box 1111 for selecting a game may show the content list of the content platform library provided from the content platform (300 in FIG. 1).

Also, the page may move back to the step of setting items to be collected as information about participants in an advertising event, illustrated in FIG. 10, by clicking the ‘previous’ button, or the step of creating an advertising event may be continued by clicking the ‘next’ button 1140. Here, the ‘next’ button 1140 is disabled by default, but may be switched to an enabled state when a game is selected. Also, when whether to change game options is set to ‘yes’, the ‘next’ button 1140 is disabled, and may then be enabled when the settings of the game options are completed.

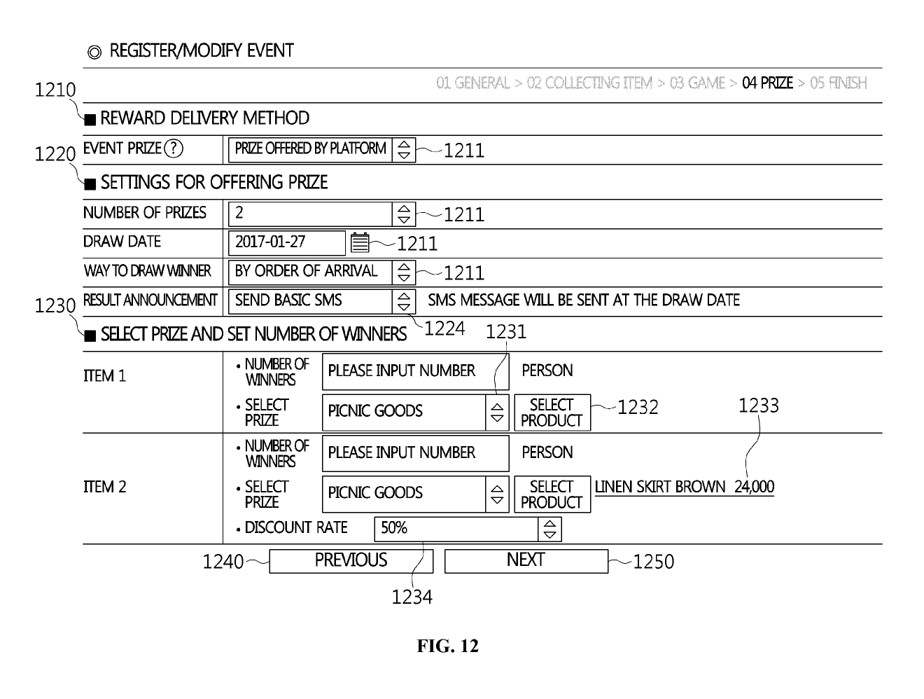

FIG. 12 is an advertising event creation page for selecting a reward (prize) delivery method 1210 and for setting reward information 1220 and information 1230 about the product to be offered as a reward.

In an embodiment, the advertising event creation page illustrated in FIG. 12 may be displayed as the next step of the advertising event creation page illustrated in FIG. 10.

In another embodiment, the advertising event creation page illustrated in FIG. 12 may be displayed as the next step of the advertising event creation page illustrated in FIG. 11.

Here, in order to enable a user to select a reward delivery method 1210, a list box 1211 for selecting a reward delivery method is displayed, ‘prize offered by platform’, ‘input prize’, and the like may be included as selectable options of the reward delivery method, and ‘prize offered by platform’ may be selected by default.

Here, when the reward delivery method 1210 is set to ‘prize offered by platform’, a prize may be offered by a shopping-mall platform that is connected to the page in order to offer a reward. That is, the reward may be offered in the form of a gift certificate, a discount coupon, and points that can be used to buy products registered in the shopping-mall platform. Accordingly, a participant in the advertising event may easily receive a reward for the advertising event using the gift certificate, the discount coupon, or points offered by the shopping-mall platform.

Also, the number of rewards 1221, the draw date 1222, a method of drawing a winner 1223, the result announcement method 1224, and the like may be set as reward information 1220. Options for the method of drawing a winner 1223 may include ‘in order of arrival’, ‘at random’, ‘based on scores in game’, and the like. Options for the result announcement method 1224 may include ‘send basic SMS’, ‘send SMS including link to gift certificate’, ‘push mobile voucher’, and the like.

Also, the information 1230 about the product to be offered as a reward may be generated so as to include as many items as the number of prizes 1221, and the number of winners, a prize, a discount rate, and the like may be set for each item. First, the category in which the product to be offered as a prize is included is selected using the list box 1231 for selecting a prize category, the product to be offered as a prize is selected by clicking the ‘select product’ button 1232, the selected product 1233 is displayed, and the discount rate 1234 is set. Here, the list box 1231 for selecting a prize category may include a list of shopping malls or a list of product types according to an embodiment.

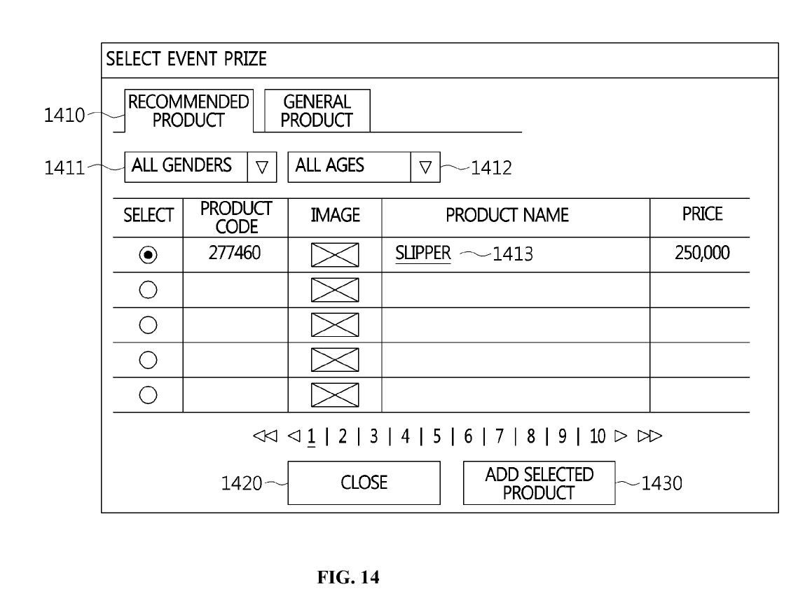

Here, when the ‘select product’ button 1232 is clicked, a page for selecting the product to be offered as a prize may be provided as shown in FIG. 14.

Also, the page may move back to the step of setting a game, illustrated in FIG. 11, by clicking the ‘previous’ button 1240, or the step of creating the advertising event may be continued by clicking the ‘next’ button 1250. Here, the ‘next’ button 1250 is disabled by default, but may be switched to an enabled state when all required items are input. Here, the required items may be information through which all matters pertaining to rewards may be finalized.

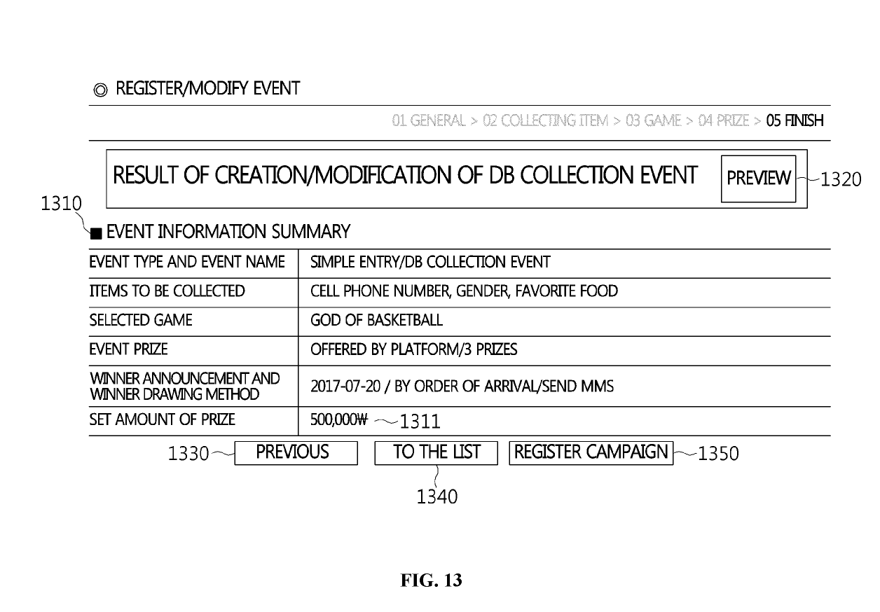

FIG. 13 is an advertising event creation page that displays event summary information 1310 about advertising event data to be created or having been created as a result of setting information about the advertising event.

In an embodiment, the advertising event creation page illustrated in FIG. 13 may be displayed as the next step of the advertising event creation page illustrated in FIG. 12.

Here, the event summary information 1310 may include the advertising event type, the advertising event name, the items to be collected, the selected game, the reward information, the set amount of a reward 1311, and the like, but items, the values of which are not set, may not be displayed. The set amount of a reward 1311 may be calculated from the set reward information. For example, when a reward is ten gift certificates, each of which is valued at ten dollars, the amount of the reward may be calculated at one hundred dollars.

Also, when the ‘preview’ button 1320 is clicked, the advertising event page to be shown to participants may be checked. Here, the advertising event preview page may be provided in the form of a window, a tab, or a pop-up window.

Also, the page may move back to the step of setting reward information, illustrated in FIG. 12, by clicking the ‘previous’ button 1330, or the page may move to a list page, in which a list of created advertising events is displayed, by clicking the ‘to the list’ button 1340. Also, when the ‘register campaign’ button 1350 is clicked, an advertising event is publicized by registering the advertising event data (advertising event campaign), whereby entry into the advertising event is permitted.

FIG. 14 is a view that shows an example of a page for selecting a product to be offered as a reward according to an embodiment of the present invention.

In an embodiment, the page shown in FIG. 14 may be displayed when the ‘select product’ button 1232 in FIG. 12 is clicked.

Specifically, the page for selecting a product to be offered as a reward may include tabs 1410, each of which shows recommended products or general products. When products recommended based on the result of analysis of advertising event results are present, the ‘recommended product’ tab shows the recommended products, and a user may select the ‘recommended product’ tab in order to check the recommended products. In order to select a product without recommendation, the ‘general product’ tab, in which a user may select a product by himself or herself, may be selected.

Here, when recommended products are present, the ‘recommended product’ tab is selected by default, but when there is no recommended product, the ‘general product’ tab may be selected by default.

Then, a product list is displayed in order to enable a user to select a product. Here, the product list may display the list of the products that are filtered by the conditions, which are set using the combo box 1411 for selecting a gender and the combo box 1412 for selecting an age group. The combo box 1412 for selecting an age group may show age groups broken into five- or ten-year intervals.

Also, the product list may include information such as product code, a product image, a product name, a price, and the like.

Here, the product name 1413 may be displayed in the form of a hyperlink to the page of a connected shopping-mall platform that sells the corresponding product. Accordingly, the user (200 in FIG. 1) may easily access the page that sells the corresponding product merely by clicking the product name 1413, and may check necessary information. The address of the page selling the product may be configured as ‘the domain of a shopping mall+product code’.

Also, when the ‘close’ button 1420 is clicked, the page may move back to the page for setting reward information without selecting a product. When the ‘add selected product’ button 1430 is clicked, the selected product is set to the product to be offered as a reward, and then the page may move back to the page for setting reward information.

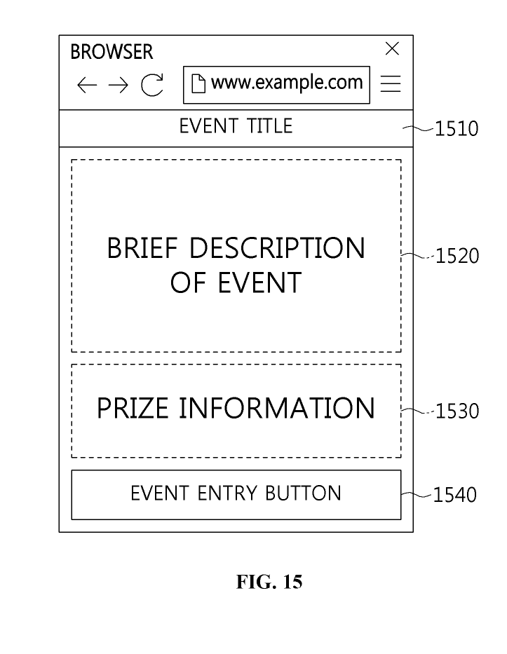

FIGS. 15 to 21 are views that show an example of an advertising event page according to an embodiment of the present invention.

Here, the advertising event page, illustrated in FIGS. 15 to 21, may be an advertising event page to be provided to a participant via the participant terminal (400 in FIG. 1), and may be an advertising event preview page provided to the user (200 in FIG. 1).

FIG. 15 is the introduction page or the start page of an advertising event, and may include an event name or an event title 1510, a brief description 1520 of an event, prize information 1530, an event entry button 1540, and the like.

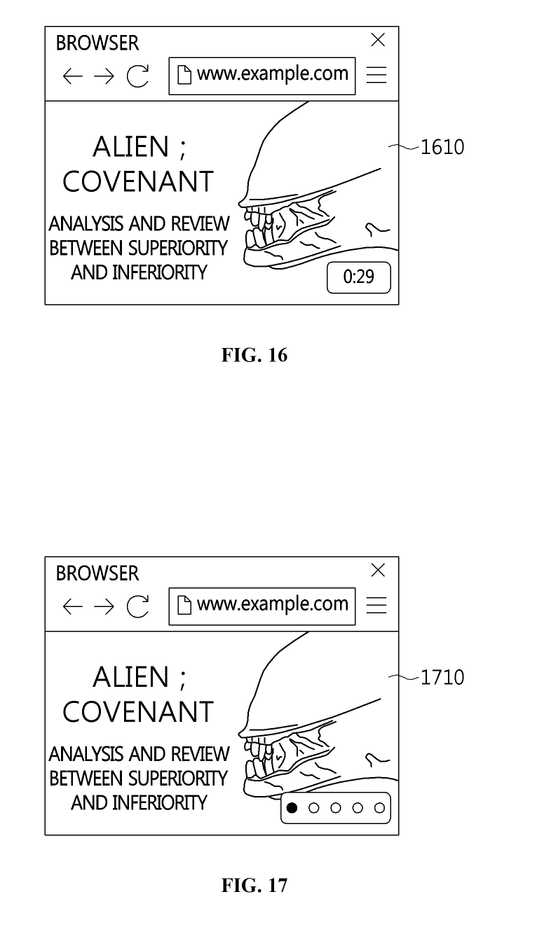

FIG. 16 is an advertisement page displayed when a video advertisement 1610 is included in the advertising event. Here, the video advertisement may be displayed by being included in the brief description 1520 of the event, illustrated in FIG. 15, or a separate page including the video advertisement may be newly loaded or may pop up when the event entry button 1540 illustrated in FIG. 15 is clicked.

FIG. 17 is an advertisement page displayed when an image advertisement 1710 is included in the advertising event. Here, the image advertisement may be displayed by being included in the brief description 1520 of the event, illustrated in FIG. 15, or a separate page including the image advertisement may be newly loaded or may pop up when the event entry button 1540 illustrated in FIG. 15 is clicked.

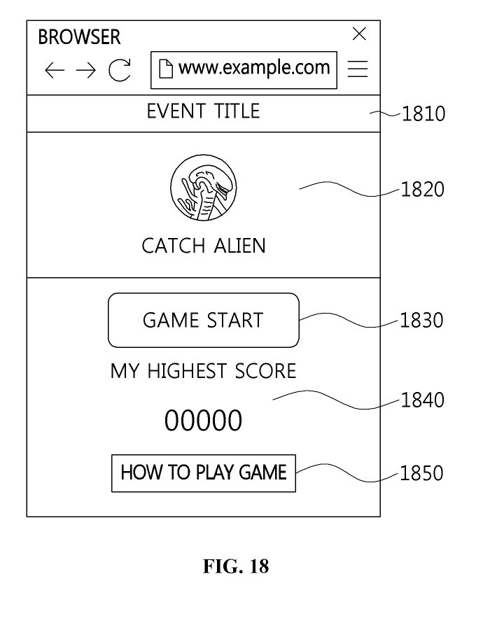

FIG. 18 is the introduction page or the start page of a mini-game included in an advertising event, and may be displayed when the event entry button 1540 illustrated in FIG. 15 is clicked. The page may include an event name 1810, a mini-game name 1820, a game start button 1830, the highest score 1840, a game description button 1850, and the like. When the game description button 1850 is clicked, information such as a brief description of the mini-game, game rules, and the like may be provided in a pop-up window.

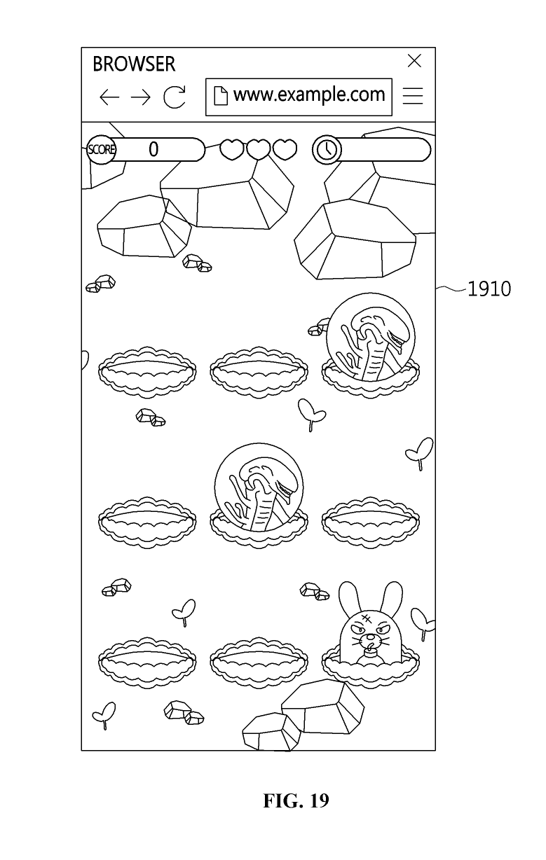

FIG. 19 is a mini-game page, and may be displayed when the game start button 1830 illustrated in FIG. 18 is clicked. This page includes the mini-game 1910 that is set as the advertising event content.

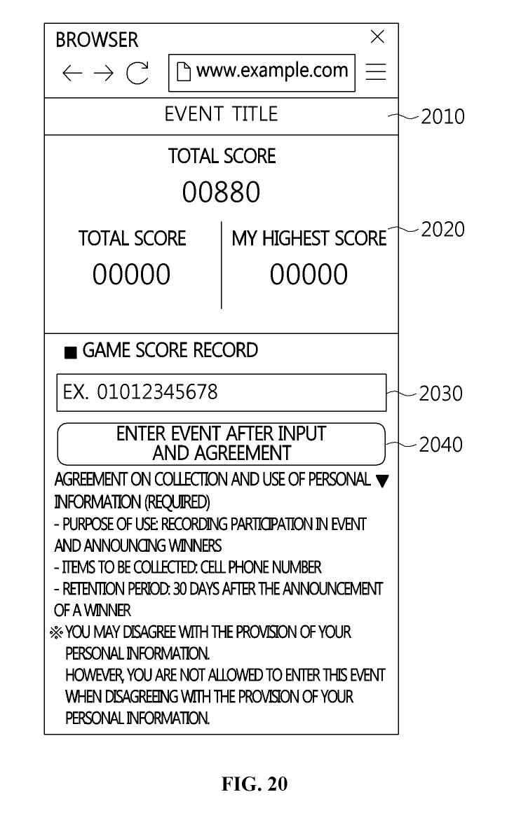

FIG. 20 is a page that shows the result of participation in the mini-game, and may be displayed when the mini-game 1910 shown in FIG. 19 finishes. The page may include the event name 2010, the score 2020, the participant information input window 2030, the participation button 2040, and the like. Information required to enter the advertising event may be input via the participant information input window 2030, and the participant may enter the event after agreeing with the provision of the input personal information by clicking the participation button 2040.

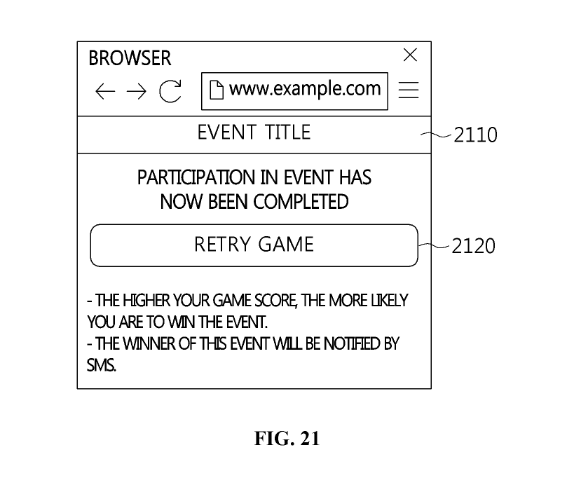

FIG. 21 is an advertising event participation completion page, and may be displayed when participation in the advertising event is successfully completed by clicking the participation button 2040 illustrated in FIG. 20. The page may include the event title 2110, an event participation completion message, a mini-game retry button 2120, and the like. The participant may retry the mini-game of the advertising event by clicking the mini-game retry button 2120, and the mini-game start page illustrated in FIG. 18 may be displayed when the mini-game retry button 2120 is clicked.

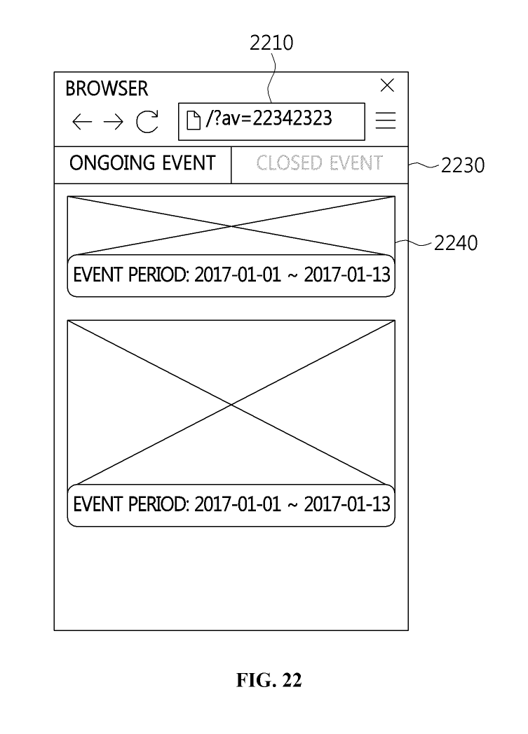

FIG. 22 is a view that shows an example of an advertising event list page according to an embodiment of the present invention.

Referring to FIG. 22, the advertising event list page according to an embodiment of the present invention includes an ongoing event tab 2220, a completed event tab 2230, and the like, and only advertising events pertaining to a certain advertiser may be displayed.

In this case, the address 2210 of the advertising event list page may be configured as ‘server domain+advertiser code’. For example, when the server domain and the advertiser code are ‘www.example.com’ and ‘22342323’, respectively, the address of the advertising event list page for the advertiser may be ‘http://www.example.com/?av=22342323’. Accordingly, when the address is accessed, a list of events in progress or a list of completed events pertaining to the advertiser may be displayed.

When the ongoing event tab 2220 is enabled, a list of the advertising events 2240 that are currently progressing may be displayed, but when the completed event tab 2230 is enabled, a list of the completed advertising events may be displayed. Also, when an advertising event is selected from the list, the page may move to a page that shows the summary information of the selected advertising event or the result of the selected advertising event.

Particularly, the advertising event list page may be inserted in or implemented to a desired webpage, site, or the like. Also, a fee may be charged when the advertising event list page is accessed or a fee to be charged may be set when permissions for accessing the advertising event list are determined.

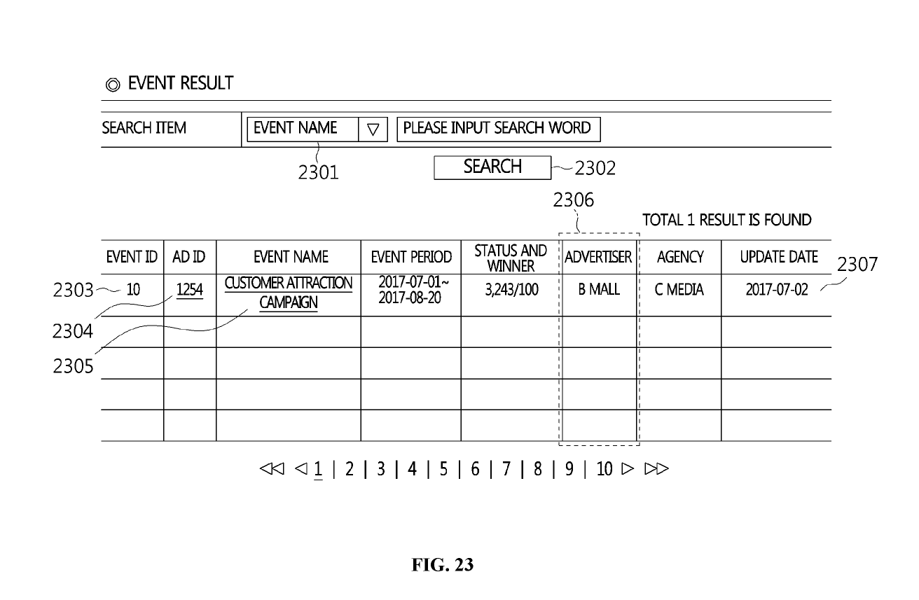

FIG. 23 is a view that shows an example of an advertising event result page according to an embodiment of the present invention.

Referring to FIG. 23, the advertising event result page according to an embodiment of the present invention may include a list box 2301 for selecting a category in which a search word is included, a search word input field, a search button 2302, a search result, and the like in order to enable searching for an advertising event.

Here, in the list box 2301 for selecting a search word category, ‘event name’ may be selected by default, and ‘event name’, ‘advertiser name’, ‘agency name’, ‘event period’, ‘event ID’, ‘advertisement ID’, and the like may be included.

When the search button 2302 is clicked, advertising events corresponding to the selected search word category and the search word are searched for, and the found advertising events are displayed. The search result may include an event ID 2303, an advertisement ID 2304, an event name 2305, an event period, current status information, an advertiser 2306, an agency, an update date 2307, and the like.

Here, the advertisement ID 2304 may be displayed in the form of a hyperlink to a page for displaying a report on the result of the corresponding advertising event. Also, the event name 2305 may be displayed in the form of a hyperlink to the page for checking or modifying the content of the corresponding advertising event. Alternatively, the event name 2305 may be displayed in the form of a hyperlink to the adverting event result details page of the corresponding advertising event. Also, the update date 2307 may be the date on which the advertising event was registered or on which the advertising event was most recently updated.

When the advertising event result page is accessed with the account of the advertiser, the advertiser 2306 field may not be displayed.

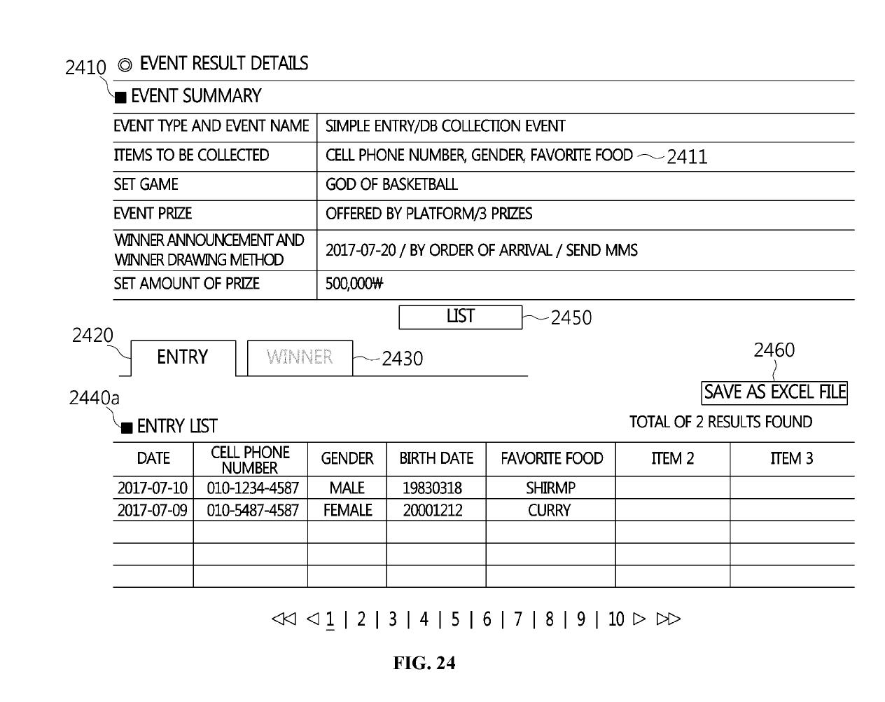

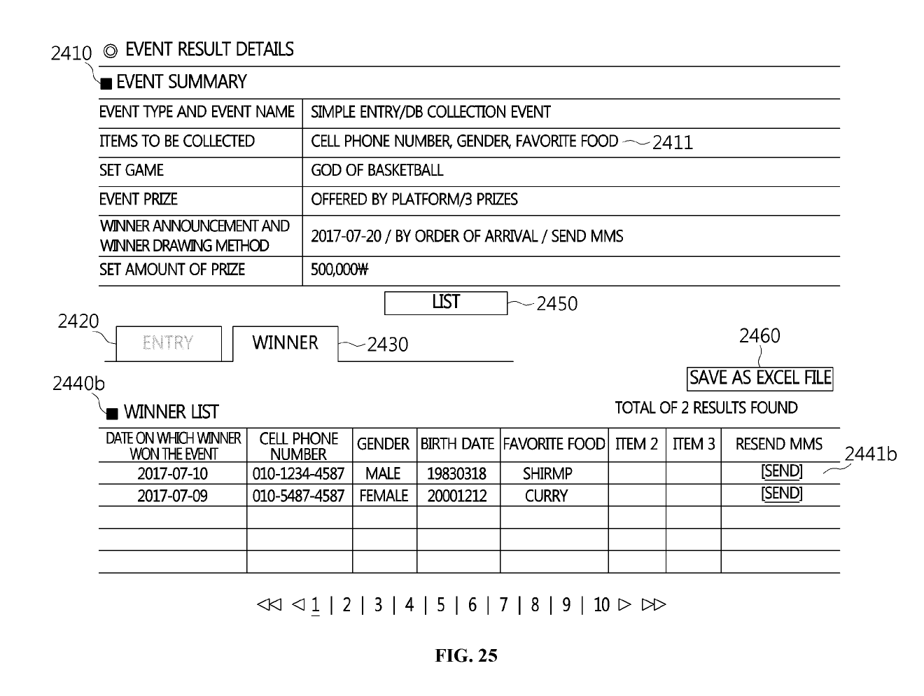

FIG. 24 and FIG. 25 are views that show an example of an advertising event result details page according to an embodiment of the present invention.

Referring to FIG. 24 and FIG. 25, the advertising event result details page according to an embodiment of the present invention includes event summary information 2410, an entry tab 2420, a winner tab 2430, an entry list 2440a or a winner list 2440b, a list button 2450, a download button 2460, and the like. Here, FIG. 24 shows an example of an advertising event result details page when the entry tab 2420 is enabled, and FIG. 25 shows an example of an advertising event result details page when the winner tab 2430 is enabled.

Here, the event summary information 2410 may include an advertising event type, an advertising event name, the collected items, the selected game, reward information, the set amount of a reward, and the like, but items, the values of which are not set, may not be displayed. The collected items 2411 may show items that are set to be collected in the advertising event.

When the entry tab 2420 is enabled, a list 2440a of entries may be displayed, and when the winner tab 2430 is enabled, a list 2440b of winners may be displayed. Here, the entry list 2440a may show participant information corresponding to the items that are set to be collected from participants. Also, the list 2440b of winners may include the date on which a winner won the event and a button or hyperlink 2441b for resending the notification of winning the event. When the notification of winning the event is sent again, the notification may be sent in the manner that is the same as the manner in which it is first set.

Also, an advertising event list page or an advertising event result page may be displayed by clicking the list button 2450. When the download button 2460 is clicked, the entry list 2440a or winner list 2440b may be download and saved as an Excel file or a spreadsheet file.

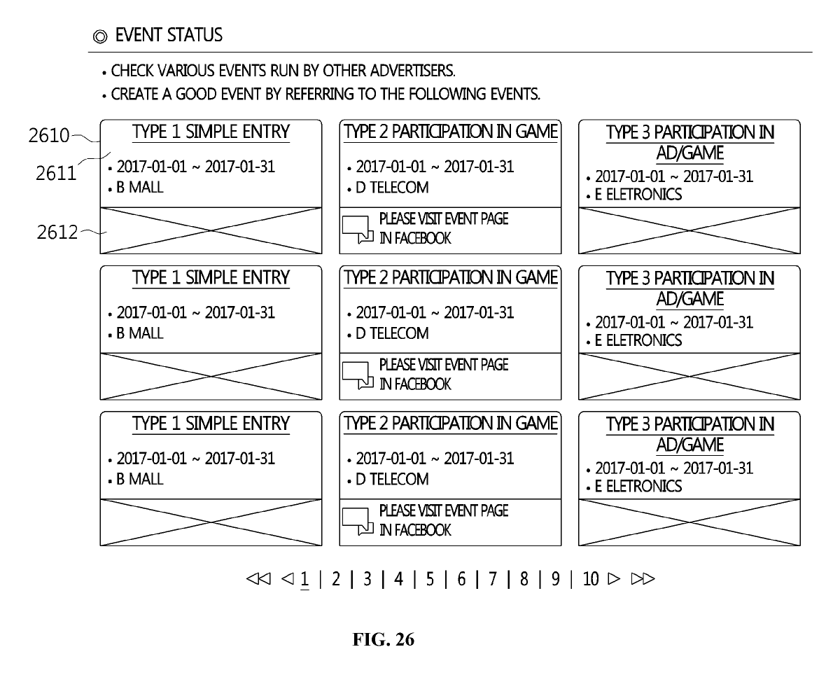

FIG. 26 is a view that shows an event status page according to an embodiment of the present invention.

Referring to FIG. 26, the event status page according to an embodiment of the present invention shows completed advertising events 2610.

Each of the advertising events 2610 includes advertising event information 2611 including an advertising event type, an advertisement period, advertiser information, and the like. Also, each of the advertising events 2610 may further include an advertising event banner 2612 that was used when the corresponding advertising event was run.

Here, when the advertising event banner 2612 is clicked, the advertising event preview page of the corresponding advertising event may be displayed. Here, the advertising event preview page may be provided in various forms, such as a window, a tab, a pop-up window, or the like.

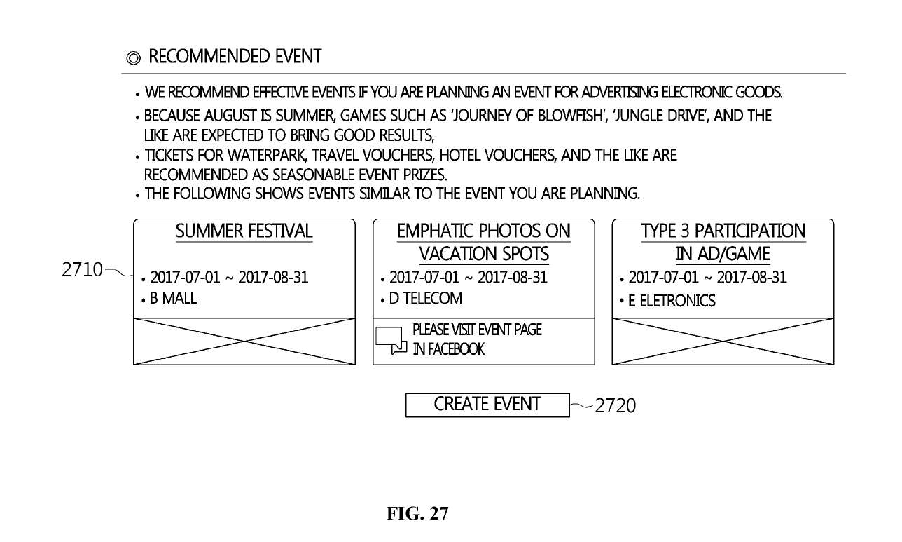

FIG. 27 is a view that shows an example of an event recommendation page according to an embodiment of the present invention.

Referring to FIG. 27, the event recommendation page according to an embodiment of the present invention provides information recommended for an advertising event in consideration of the category in which the product to be advertised is included, the time at which an advertisement is to be publicized, and the like. Also, among the advertising events that were run, advertising events 2710 that are similar to the advertising event that the user (200 in FIG. 1) intends to provide may be selected and displayed.

For example, when the product that the user (200 in FIG. 1) wants to advertise is included in an electronic device category, an advertising event type, advertising event content, and the like that have yielded good advertising effects in the electronic device category may be recommend. Also, when the time when the advertisement is to be publicized is August, mini-games related to summer may be recommended as game content, and tickets for a waterpark, associated with summer, may be recommended as rewards.

Also, an event creation button 2720 is provided so that the user (200 in FIG. 1) is prompted to move to the advertising event creation page.

FIG. 28 is a block diagram that shows the configuration of a system 28 for exchanging advertising media according to an embodiment of the present invention.

Referring to FIG. 28, in the system 28 for exchanging advertising media according to an embodiment of the present invention, an apparatus 2800 for exchanging advertising media is interconnected with at least one event provision device 2900 and at least one advertising media provision device 3000.

Also, in the system 28 for exchanging advertising media according to an embodiment of the present invention, the apparatus 2800 for exchanging advertising media may include at least one of the event provision device 2900 and the advertising media provision device 3000 as a module. That is, the apparatus 2800 for exchanging advertising media may have the function of providing an event, or may have the function of providing an advertising media. Also, as will be described later, the apparatus 2800 for exchanging advertising media may have the function of creating an event.

The apparatus 2800 for exchanging advertising media according to an embodiment of the present invention determines one or more candidate events that can be interchanged with a prize event in order to exchange advertising media, and determines the exchange target event to be interchanged with the prize event from among the candidate events. Then, an exchange ratio between the prize event and the exchange target event is determined, and the prize event is allocated to the exchange target advertising media corresponding to the exchange target event based on the exchange ratio. Hereinafter, an event, the exchange of which is requested, (referred to as an exchange request event) and the prize event may be used interchangeably with each other unless they are meaningfully different. Also, an exchange request medium may be used interchangeably with a prize event advertising media corresponding to a prize event unless they are meaningfully different. Also, an advertising media, a media, an advertising medium and a medium may be used interchangeably with each other, and an advertising event and an event may be used interchangeably with each other.

Here, an advertising media indicates advertising space in which an event is to be displayed, and may include various advertising sections in applications and webpages, and the like. For example, a banner advertisement section, a full-page advertisement section, a pop-up advertisement section, and the like are advertising media. Also, an event may include text, images, sound, videos, games and the like as advertising content. Particularly, the event may be created using the advertising-event-authoring tool.

Also, a candidate event may be a prearranged event, or may correspond to an unscheduled future event. Also, the candidate event may correspond to the approval of allocation of an event of another medium to the corresponding medium. For example, assume that user A wants to post his or her prize event on the advertising medium of another user. In this case, even though user B has no advertising event at present, user B may interchange his or her advertising medium with the advertising medium of user A in order to interchange his or her advertising event with the prize event of user A in the future. Particularly, the event period of the candidate event may differ from that of the prize event. That is, the event period of the candidate event may partially overlap that of the prize event, or the event period of the candidate event may not overlap that of the prize event. When the event period of the candidate event does not overlap that of the prize event, the candidate event may be a future event or may be understood to mean approval of allocation of another event to the corresponding medium.

Also, the candidate event may be selected in consideration of one or more of a period factor, calculated based on the event period of a prize event and that of a candidate event, a media utility factor of an advertising media corresponding to the prize event and an advertising media corresponding to the candidate event, and a prize factor, calculated based on information about the prize of the prize event and that of the candidate event.

That is, the apparatus 2800 for exchanging advertising media may select the exchange target event to be interchanged with a certain advertising event (prize event) in order to exchange advertising media, and may allocate the prize event to the exchange target advertising media of the exchange target event. Here, the event to be allocated may include the event that is created using the advertising-event-authoring tool (100 in FIG. 1). For example, when advertising media a1 is placed in the application of user A and when advertising media b1 is placed in the application of user B, user A may create prize event a2 using the apparatus 2800 for exchanging advertisement media, and may post event a2 of user A on advertising media b1.

Here, the apparatus 2800 for exchanging advertising media may collect and analyze the advertising results of advertising media and events. Accordingly, the advertising effect of each of the advertising media and events may be detected. That is, after advertising results are collected, the advertising result of each of the advertising media may be analyzed, and the advertising result of each of the events may be analyzed. For example, individual and collective advertising results of the events shown through advertising media a1 may be analyzed, and the collective advertising result of event a2 and individual advertising results of the respective advertising media used to show event a2 may be analyzed.

Here, the apparatus 2800 for exchanging advertising media may evaluate the value of each of the advertising media and each of the events using the advertising results. The value of each of the advertising media and each of the events may be the expense corresponding thereto. For example, when the value of advertising media a1 is compared with the value of advertising media b1, advertising media a1 may be evaluated as having twice the value of advertising media b1. Similarly, when the value of event a2 is compared with the value of event b2, event a2 may be evaluated as having twice the value of event b2.

Here, in order to evaluate the value, the apparatus 2800 for exchanging advertising media may use at least one of the number of advertising exposure, the number of clicks, the number of times an app is installed due to the influence of the advertisement, the number of activities due to the influence of advertisement, a click-through rate, a conversion rate, a retention rate, the number of secured users, the number of active users, the number of active users during a preset time, the number of users with paid subscriptions, a profit of each user, an advertisement rate calculation method, an advertisement expense, the total value of prizes, the number of winners, the value of a prize for each winner, a target group, and main customers. Here, information about the target group and the main customers may include personal information such as ages, genders, occupations and the like, and may be used to calculate a weight for the value. Also, traffic data for each event or Return-on-Investment (ROI) for each advertising purpose of a specific advertiser may be used. Also, a Unique Visitor (UV), a Page View (PV), the rate of entry to each event phase, an abandonment rate, and the like may be used.

Here, the apparatus 2800 for exchanging advertising media may calculate a weight parameter including a weight for the day of the week, a weight for the date, or a weight for the time of each advertising media. For example, if the advertising effect produced by a certain advertising media on the weekend is determined to be more than twice the advertising effect on weekdays, when a weight for the day of the week is set, the weight for the weekend may be set to twice the weight for weekdays. Similarly, if the advertising effect produced by a certain advertising media during commuting hours is determined to be more than three times the advertising effect during work hours, when a weight for the time is set, the weight for commuting hours may be set to three times the weight for working hours.

Here, the apparatus 2800 for exchanging advertising media may determine an exchange ratio using the exchange index of a prize event (an exchange request event) and the exchange index of an exchange target event. Here, the exchange index may be calculated in consideration of event period information, prize information, media utility information, the evaluated value of a media, the value of an event, a weight parameter, and the like.

Here, the weight parameter may be the weight for the value related to time information, such as the date or the day of the week on which the advertisement is allocated, or the time at which the advertisement is allocated. For example, the value for the weekend and holidays may be set to twice the value for weekdays. Also, different values may be set for commuting hours, daylight hours, late hours, early-morning hours, and the like.

Here, the apparatus 2800 for exchanging advertising media may set the exchange ratio to the ratio of exchange indices, a preset preference ratio, or the ratio of exchange indices modified by incorporating a preset additional expense therein. For example, when the ratio of exchange indices is 2:1, the exchange ratio may be set to 2:1. Alternatively, when the exchange index of media a is 2× dollars and the exchange index of medium b is x dollars, if the preset preference ratio is 1:1, the exchange ratio may be set to 1:1, and the additional expense to be charged to medium b may be set to x dollars. Alternatively, when the exchange indices of medium a and medium b are 2× dollars and x dollars, respectively, and when a preset additional expense corresponding to medium b is x dollars, the ratio of exchange indices modified by incorporating the preset additional expense therein is 1:1, thus the exchange ratio may be set to 1:1. Here, the exchange index is represented in monetary units, but may be represented in units of points.

Here, the exchange ratio may be information related to at least one of the ratio between the number of exposures of one event and that of another event, the ratio between the frequency of exposures of one event and that of another event, the ratio between a period during which one event is shown and a period during which another event is shown, information about windows of time throughout the day in which an event is shown, the ratio of advertisement expenses or costs, and additional expense information.

Here, the apparatus 2800 for exchanging advertising media may calculate a fee for exchanging media and additional expenses incurred from the imbalance of the values of media. For example, when media are interchanged, the fee for the advertising media exchange service may be calculated using the values of the media. Also, when the ratio of exchange indices is 2:1, the exchange ratio is set to 1:1, and the difference between the exchange indices may be calculated as the additional expense. Accordingly, the imbalance of the values of the media to be interchanged with each other is resolved using the additional expense, whereby the values may be equalized. Also, the fee for the advertising media exchange service may be calculated. Here, the additional expense or the fee may be calculated in units of a reserve fund or points, and the reserve fund or points may be used to interchange media, or may be exchanged for cash.

Here, the apparatus 2800 for exchanging advertising media may set an exchange ratio in consideration of an additional expense that depends on the selection of a user. That is, an exchange ratio for equalizing values only through the exchange of media without any additional expense may be calculated, or an additional expense may be set, and then an exchange ratio for equalizing the values based on the additional expense may be calculated. For example, when the expense of showing event b2 in advertising media a1 of user A is 2× dollars per hour and when the expense of showing event a2 in advertising media b1 of user B is 1× dollars per hour, user A and user B interchange their events at the same rate, and user B may pay 1× dollars per hour to user A as the additional expense. Here, the expense may be paid from a reserve fund, and the difference between the expenses may be offset through the additional interchange with another media.

Here, the apparatus 2800 for exchanging advertising media may determine one or more candidate events interchangeable with a prize event using at least one of advertising results, the correlation between advertising media, the correlation between events, and the correlation of advertising media with events. For example, when the correlation indicates that people who like movies like coffee, a coffee shop event may be selected as a candidate event for a movie theater event.

Here, when candidate events are recommended, the correlation between the characteristics of an advertising target group may be analyzed. The characteristics of an advertising target group may include an age, a gender, an occupation, a residence, a place of work, a living radius, a life pattern, a life style, an income, a level of education, a religion, credit information, interests, hobbies, spending habits, the frequency of financial transactions, and the like. For example, if women tend to often use a coffee shop application and participate in an advergame, a game participation event may be selected as an event to be recommended for an advertising media placed in the coffee shop application. Also, when candidate events are recommended, category information of the event and the advertising media may be considered. That is, the advertising effects and the correlation of the advertising media with events are detected through the analysis of advertising results, and a candidate event expected to bring good advertising effects may be recommended.

Here, using the recommended candidate events, the apparatus 2800 for exchanging advertising media may determine the exchange target event, either automatically or depending on user input. For example, in the mode in which media are automatically interchanged, the candidate event may be determined as the exchange target event. For example, when one of the candidate events is selected as the exchange target event, the candidate event having the highest priority may be automatically selected as the exchange target event. In the mode in which media are manually interchanged, information about the candidate events are provided in order to help a user select the event to interchange, and the exchange target event may be selected depending on user input.

Here, the apparatus 2800 for exchanging advertising media may divide advertising media into pairs and interchange the events of the media forming a pair in a one-to-one manner, or may divide advertising media into groups, each of which includes three or more advertising media, and interchange events of the media within a group. For example, when user A has advertising media a1 and event a2 and user B has advertising media b1 and event b2, they interchange the events in a one-to-one manner, so that event b2 may be allocated to advertising media a1, and event a2 may be allocated to advertising media b1. Also, when user A has advertising media a1 and event a2, user B has advertising media b1 and event b2, and user C has advertising media cl and event c2, they may interchange the events in such a way that event b2 is allocated to advertising media a1, event c2 is allocated to advertising media b1, and event a2 is allocated to advertising media c1. That is, in order to interchange advertisements, two companies (users) interchange events in a one-to-one manner such that an event is allocated to the other's media, or the events of multiple companies (users) may be interchanged between their media.

Accordingly, users who provide advertising media or events may reduce expenses by easily interchanging events therebetween, and advertising media may be reasonably interchanged based on an exchange ratio in which the values of the advertising media and events are incorporated. Also, because a suitable target to be interchanged is recommended, users may obtain better advertising effects from the same investment.

In an alternative embodiment, for users who provide only advertising media or only events, the apparatus 2800 for exchanging advertising media may allocate events to advertising media by charging the expense therefor to the users. For example, when user A provides only an advertising media and when user B provides only an event, the event of user B may be allocated to the advertising media of user A by charging the expense. Here, the user who provides only an advertising media may be a developer or a publisher who has a profit model using an ad network. In this case, the user who provides only an advertising media may exchange media in such a way that the user interchanges his or her unscheduled future event with the current event of another user.

Also, a reserve fund or points may be given to the user who provides only an advertising media, whereby, when the user provides both an advertising media and an event in the future, the user may use the reserve fund or the points in order to interchange the event. Here, the event of the user who provides only an advertising media may be an unscheduled future event, and may correspond to the approval of allocation of the event of another user to his or her medium. Accordingly, the user who has no advertising event and provides only an advertising media may exchange the advertising media with another user.

The event provision device 2900 is a device for providing an event to be used in an advertisement. Here, the event provision device 2900 may include the function of creating an event. Also, the event provision device 2900 includes an event database, and may provide an advertising event stored in the event database. Particularly, the event provision device 2900 may be the apparatus (100 in FIG. 1) for providing an advertising-event-authoring tool.

Accordingly, a user may easily create an advertising event, and may show the advertising event by exchanging advertising media suitable for the advertising purpose and advertising effects.

As described above, the event provision device 2900 may be configured to be separate from the apparatus 2800 for exchanging advertising media, but may be configured as a module or a function of the apparatus 2800 for exchanging advertising media. That is, an advertising event is easily created, and an exchange target event to be interchanged with the created advertising event is determined, whereby advertising media corresponding to the created advertising event and the exchange target event may be interchanged with each other.

The advertising media provision device 3000 may be a device for providing an advertising media to be used to show an event. Here, the advertising media provision device 3000 detects information about available advertising media, and may provide events that are allocated to the respective advertising media. Also, the advertising media provision device 3000 may include an advertising media database.

As described above, the advertising media provision device 3000 may be configured to be separate from the apparatus 2800 for exchanging advertising media, but may alternatively be configured as a module or a function of the apparatus 2800 for exchanging advertising media.

Accordingly, a user may easily create and use an advertising event, or may use a created advertising event using the advertising event provision device 2900. Also, an advertising event to be interchanged with the prize event of a user may be determined, and the advertising events are interchanged such that each of the advertising events is allocated to the other's advertising media, whereby advertising media may be interchanged with each other.

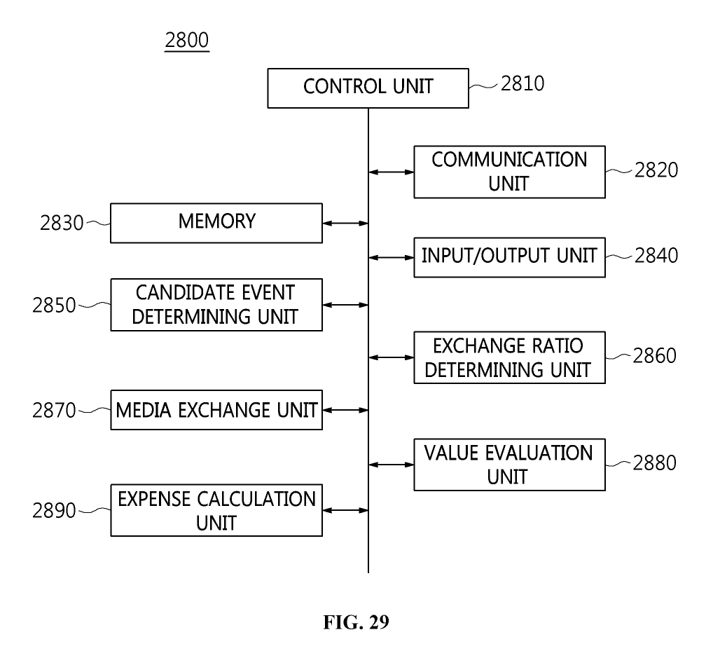

FIG. 29 is a block diagram that shows an example of the configuration of the apparatus 2800 for exchanging advertising media illustrated in FIG. 28.

Referring to FIG. 29, the apparatus 2800 for exchanging advertising media according to an embodiment of the present invention includes a control unit 2810, a communication unit 2820, memory 2830, an input/output unit 2840, a candidate event determining unit 2850, an exchange ratio determining unit 2860, a media exchange unit 2870, a value evaluation unit 2880, an expense calculation unit 2890, and the like.

Specifically, the control unit 2810 is a kind of central processing unit, and controls the overall process for exchanging advertising media. That is, the control unit 2810 may provide various functions by controlling the communication unit 2820, the memory 2830, the input/output unit 2840, the candidate event determining unit 2850, the exchange ratio determining unit 2860, the media exchange unit 2870, the value evaluation unit 2880, the expense calculation unit 2890, and the like.

Here, the control unit 2810 may include all kinds of devices capable of processing data, such as a processor and the like. Here, a ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 2820 provides a communication interface through which signals may be sent to and received from the event provision device (2900 in FIG. 28) and the advertising media provision device (3000 in FIG. 28).

Here, the communication unit 2820 may be a device including hardware and software that are necessary in order to send and receive signals, such as control signals or data signals, through a wired or wireless connection with another network device.

Here, the communication unit 2820 may receive events or information corresponding to events from the event provision device (2900 in FIG. 28), and may receive information corresponding to advertising media from the advertising media provision device (3000 in FIG. 28).

The memory 2830 functions to temporarily or permanently store data processed by the control unit 2810. Here, the memory 2830 may include magnetic storage media or flash storage media, but the present invention is not limited thereto.

The input/output unit 2840 is a device for receiving a control signal for exchanging events or advertising media from a user. Also, the input/output unit 2840 outputs information, such as information about advertising media to be exchanged and events to be exchanged, advertising media exchange information, schedule information, an exchange ratio, fees, additional expenses, and the like. Here, the input/output unit 2840 may include a keyboard, a mouse, a touchpad, a touch panel, a display device for outputting visual information, a speaker device for outputting sound, and the like.

The candidate event determining unit 2850 determines one or more candidate events to be interchanged with a prize event (exchange request event). That is, in order to exchange media, events to be allocated to media are determined. Here, a candidate event may be not only a prearranged event but also an unscheduled future event. Also, the candidate event may be understood as the approval of allocation of an event posted on another medium to the corresponding medium.

Here, the candidate event determining unit 2850 may determine a candidate event in consideration of one or more of a period factor, calculated based on the event period of the prize event and that of a candidate event, a media utility factor of an advertising media corresponding to the prize event and an advertising media corresponding to a candidate event, and a prize factor calculated based on information about the prize of the prize event and that of a candidate event. Also, the candidate event may be selected by additionally using at least one of an advertising result, the correlation between advertising media, the correlation between events, and the correlation of the media with the events. Particularly, a weight is calculated and reflected based on information about the ages of people in a target group and the ages of main customers of media, whereby candidate events may be selected based thereon. For example, when a prize event is aimed at people in their 20s, an advertising event that is posted on an advertising media, the main customers of which are people in their 20s, may be selected as a candidate event.

As described above, because a candidate event is selected and provided, a user (advertiser) may obtain information about an advertising media and an exchange target event to be interchanged with his or her advertising media and event in order to more effectively and efficiently advertise his or her event.

The exchange ratio determining unit 2860 determines an exchange ratio between a prize event and an exchange target event, which is determined based on the candidate events.

Here, the exchange ratio determining unit 2860 may determine an exchange ratio based on the exchange indices of the respective media. Here, the exchange index may be set in consideration of a period factor corresponding to an event period, a media utility factor of an advertising media, a prize factor corresponding to an event prize, an event expense factor corresponding to the expense of an event, and the like. In order to set a period factor, the length of a period during which an event is to be provided (for example, ten days), windows of time throughout the day in which an event is to be provided (for example, commuting hours), and the like may be considered. The media utility factor indicates the utility of a media, corresponding to the value thereof, and the effects of an event posted on the media, the distribution of customers who use the media (for example, distribution of customers based on ages or genders), the number of visitors per month, the number of visitors per day, the number of page views (PVs), and the like may be considered. The prize factor may be calculated based on a prize evaluation index, and information such as a total prize money, a prize money to be offered to each winner, and the like may be considered when the prize evaluation index is set. The event expense factor may be set in consideration of the type of an event, the expense of creating an event, event content, and the like. Particularly, a media-weight may be calculated depending on the distribution of customers. For example, when main customers are people in their teens, 20s, 30s, and 40s, the media-weight may be set to 110%, 120%, 130%, and 90%, respectively.

For example, when the utility factor of the media of user A is 100, when the main customers are people in their 40s, when the prize factor of the event of user A is 100, when the event is aimed at people in their 20s, when the event period is ten days, and when the number of winners is 100, the exchange index of user A may be calculated to 180 ((100+100)*90%) in consideration of the utility factor, the prize factor, and the media-weight. Accordingly, the media of user A may be determined to have a value of 18 per day (180/10). When user A requests to exchange media, the media of user B, who also wants to exchange media and has conditions in which the event period overlaps that of the media of user A and the main customers are people in their 20's, may be found. Here, when the exchange index of user B is 120 and the event period is 20 days, the media of user B may be determined to have a value of 6 per day (120/20). Accordingly, because the value of the media of user A is three times the value of the media of user B, user B may pay the expense for the difference, user B may show the event of user A for an amount of time three times the event period of user B, or user A may interchange his or her media with another user's media, the value of which corresponds to the difference. That is, the exchange ratio may be set to the ratio of exchange indices, but may be set to a ratio that is different from the ratio of exchange indices and an additional expense corresponding to the difference may be paid, or another media having a value corresponding to the difference may be interchanged therewith.

Here, even when the event is underway, the exchange ratio determining unit 2860 may update the exchange ratio in consideration of the remaining period, the current status related to entry to the event, the current status related to winning, the probability of winning the event, and the like.

Here, the exchange ratio determining unit 2860 monitors event progress status information during the event period of an exchange request event, and may adjust the exchange ratio within the event period based on the event progress status information. Also, the probability of winning the event during the event period of the exchange request event is calculated in order to check the number of participants in the event so far, and the exchange ratio may be adjusted based on the calculated probability within the event period. Also, when the number of participants in the event during the event period of the exchange request event does not reach a criterion, the exchange ratio may be modified within the event period such that the exchange request event is to be shown more frequently as the probability of winning the event is higher. For example, when user A exchanges advertising media with user B, and when participation in the event of user A, which is posted on the media of user B, is determined to be low, the exchange ratio may be adjusted in order to more frequently show the event of user A. Particularly, the exchange ratio may be adjusted in order to show the event of user A more frequently as the probability of winning the event of user A is higher.

The media exchange unit 2870 interchanges a prize event advertising media corresponding to a prize event with an exchange target advertising media corresponding to an exchange target event based on the exchange ratio. That is, each of the advertising events determined to be interchangeable with one another is allocated to the other's advertising media, whereby the advertising media may be exchanged.

Here, the media exchange unit 2870 may divide advertising media into pairs and exchange the events of the media forming a pair in a one-to-one manner, or may divide advertising media into groups, each of which includes three or more advertising media, and exchange the events of the media within a group. For example, when user A has advertising media a1 and event a2 and user B has advertising media b1 and event b2, the events are interchanged in a one-to-one manner, so that event b2 may be allocated to advertising media a1 and event a2 may be allocated to advertising media b1. Also, when user A has advertising media a1 and event a2, user B has advertising media b1 and event b2, and user C has advertising media cl and event c2, the events may be interchanged in such a way that event b2 is allocated to advertising media a1, event c2 is allocated to advertising media b1, and event a2 is allocated to advertising media cl.

The value evaluation unit 2880 evaluates the value of each of advertising media and events. Here, the value of each of advertising media and events may be used to calculate an exchange ratio or an additional expense.

Here, the value evaluation unit 2880 may evaluate a value using at least one of an event period, the target group of an event, a period during which an advertisement is to be shown, the number of winners of an event, a total value of prizes, a value of a prize to be offered to each winner, the number of exposures of an event, the number of clicks on an event, the number of times an app is installed due to the influence of an event, the number of activities performed in order to participate in an event, a click-through rate, a conversion rate, a retention rate, the number of secured users, the number of active users, the number of active users during a preset period, the number of users with paid subscriptions, a profit per user, an event expense calculation method, and an event expense.

The expense calculation unit 2890 calculates an expense that includes one or more of a fee for the exchange of advertising media and an additional expense incurred during the exchange of the advertising media. Here, the expense may be accumulated in the form of a reserve fund.

Here, the expense calculation unit 2890 may calculate a fee for the media exchange service based on the values of the exchanged media. For example, a certain percentage of the value of the exchanged media may be charged as the fee.

Here, when the media are exchanged based on the exchange ratio, if the values of the media to be exchanged are determined to be disproportionate, the expense calculation unit 2890 may set the difference between the values of the media as an additional expense. For example, when medium al having a value of x dollars and medium a2 having a value of 2× dollars are interchanged in equal proportion, the additional expense to be paid by medium al may be calculated to be x dollars.

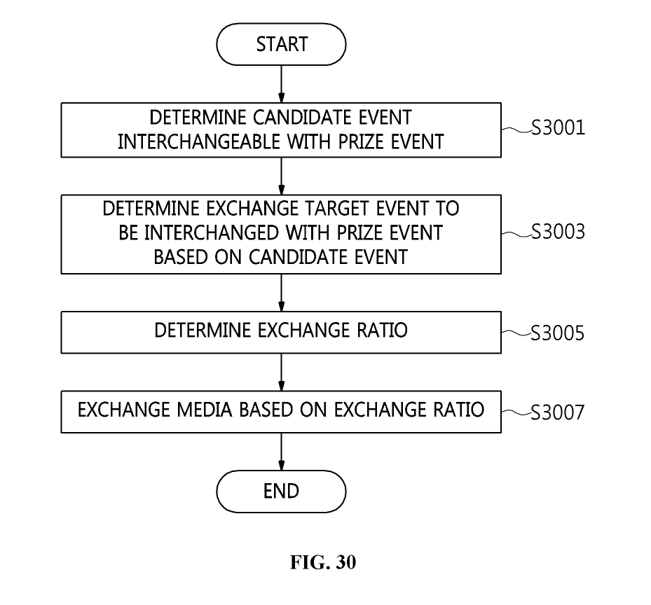

FIG. 30 is a flowchart that shows a method for exchanging advertising media according to an embodiment of the present invention.

Referring to FIG. 30, in the method for exchanging advertising media according to an embodiment of the present invention, the apparatus (2800 in FIG. 28) for exchanging advertising media determines one or more candidate events interchangeable with a prize event (an exchange request event) at step S3001.

Here, a candidate event may be selected in consideration of one or more of a period factor calculated based on the event period of the prize event and that of the candidate event, a media utility factor of an advertising media corresponding to the prize event and an advertising media corresponding to the candidate event, and a prize factor calculated based on information about the prize of the prize event and that of the candidate event.

Particularly, the prize event, the exchange of which is requested, may be an advertising event created using the apparatus (100 in FIG. 1) for providing an advertising-event-authoring tool.

Also, in the method for exchanging advertising media according to an embodiment of the present invention, the apparatus (2800 in FIG. 28) for exchanging advertising media determines the exchange target event from among the candidate events at step S3003.

Also, in the method for exchanging advertising media according to an embodiment of the present invention, the apparatus (2800 in FIG. 28) for exchanging advertising media determines an exchange ratio between the prize event and the exchange target event at step S3005.

Here, the exchange ratio may be set based on the exchange index of the prize event and that of the exchange target event.

Also, in the method for exchanging advertising media according to an embodiment of the present invention, the apparatus (2800 in FIG. 28) for exchanging advertising media exchanges media based on the exchange ratio at step S3007.

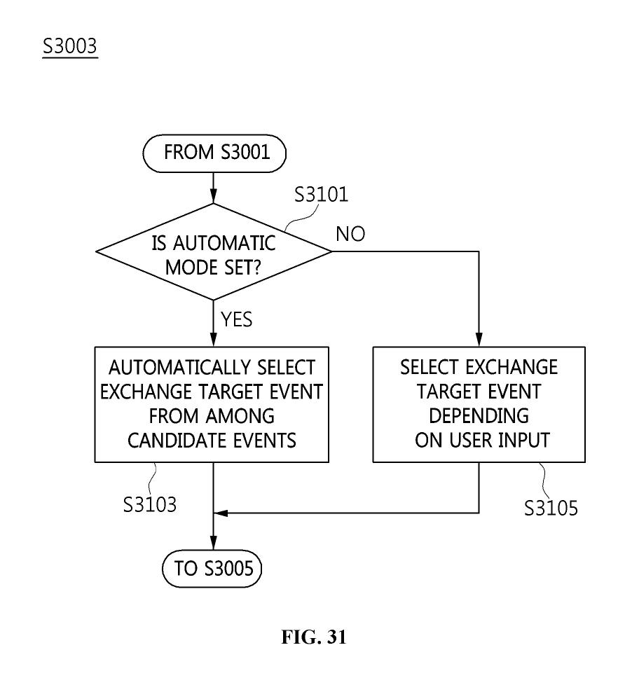

FIG. 31 is a flowchart that shows an example of the step (S3003) of determining the exchange target event, illustrated in FIG. 30.

Referring to FIG. 31, in the step (S3003) of determining the exchange target event, whether a mode for determining the exchange target event is an automatic mode is determined at step S3101.

When it is determined at step S3101 that the mode is an automatic mode, the exchange target event is automatically determined from among the candidate events at step S3103. For example, the preset number of events may be automatically selected as the exchange target events based on a priority order from among the candidate events.

When it is determined at step S3101 that the mode is not an automatic mode, the exchange target event is determined depending on user input at step S3105. Here, information about the candidate events and information about advertising media corresponding to the candidate events may be provided to a user, and the user may select a desired one from among the candidate events, whereby the exchange target event may be selected.

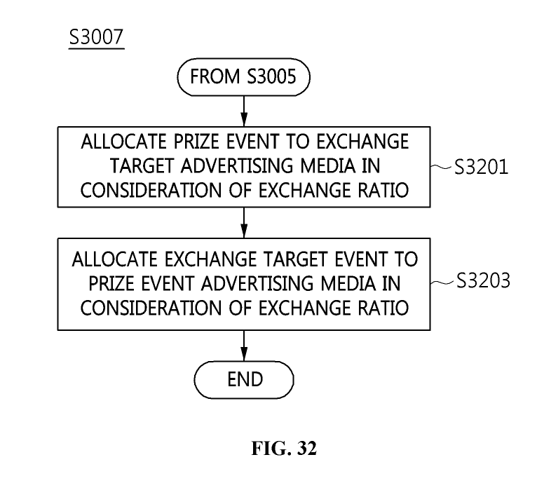

FIG. 32 is a flowchart that shows an example of the step (S3007) of exchanging media, illustrated in FIG. 30.

Referring to FIG. 32, in the step (S3007) of exchanging media illustrated in FIG. 30, the prize event is allocated to a target advertising media corresponding to the exchange target event in consideration of the exchange ratio at step S3201.

Also, in the step (S3007) of exchanging media illustrated in FIG. 30, the exchange target event is allocated to the advertising media corresponding to the prize event in consideration of the exchange ratio at step S3203.

In an alternative embodiment, allocating the prize event to the advertising media corresponding to the exchange target event at step S3201 may be performed in parallel with allocating the exchange target event to the advertising media corresponding to the prize event at step S3203.

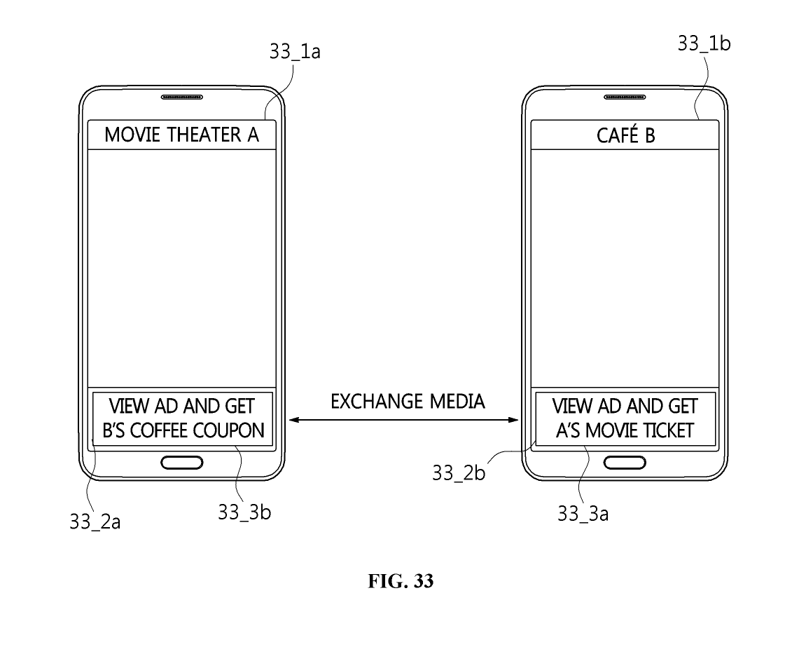

FIG. 33 is a view that shows an example in which media are exchanged in an embodiment of the present invention.

Referring to FIG. 33, movie theater A provides an advertising media 33_2a in its application or webpage 331a, and there is an event 33_3a for advertising movie theater A. Also, café B provides an advertising media 33_2b in its application or a webpage 33_1b, and there is an event 33_3b for advertising café B.

Here, movie theater A and café B exchange their media, so that the event 33_3b of café B is allocated to the advertising media 33_2a of the application 331a of movie theater A, and that the event 33 3a of movie theater A is allocated to the advertising media 33_2b of the application 33_1b of café B.

Particularly, when the main customers of the movie theater overlap those of the café or when there is an association between the movie theater and the café, the event of the medium 33 2a of movie theater A and the event of the medium 33 2b of café B may be recommended as events to be interchanged with each other.

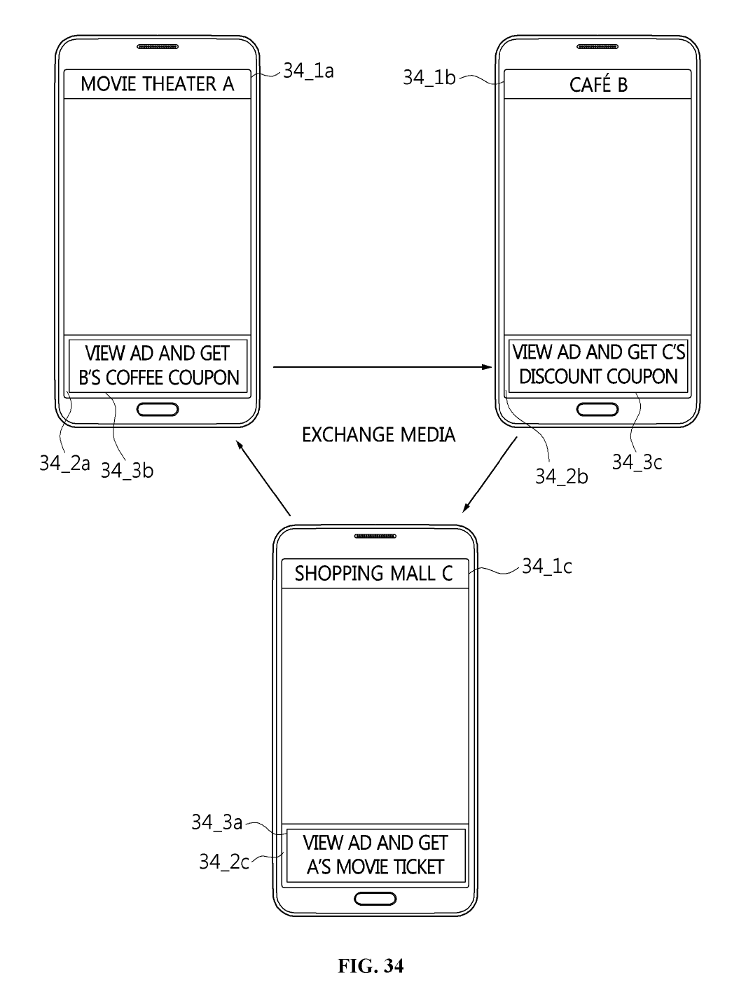

FIG. 34 shows an example that shows an example of the exchange of media in an embodiment of the present invention.

Referring to FIG. 34, movie theater A provides an advertising media 34_2a in its application or webpage 34_1a and has an event 34_3a for advertising itself. Also, café B provides an advertising media 34_2b in its application or webpage 34_1b and has an event 34_3b for advertising itself Also, shopping mall C provides an advertising media 34_2c in its application or webpage 34_1c and has an event 34_3c for advertising itself.

Here, movie theater A, café B, and shopping mall C exchange their media in such a way that the event 34_3b of café B is allocated to the advertising media 34_2a in the application 34_1a of movie theater A, the event 34_3c of shopping mall C is allocated to the advertising media 34_2b in the application 34_1b of café B, and the event 34_3a of movie theater A is allocated to the advertising media 34_2c in the application 34_1c of shopping mall C.

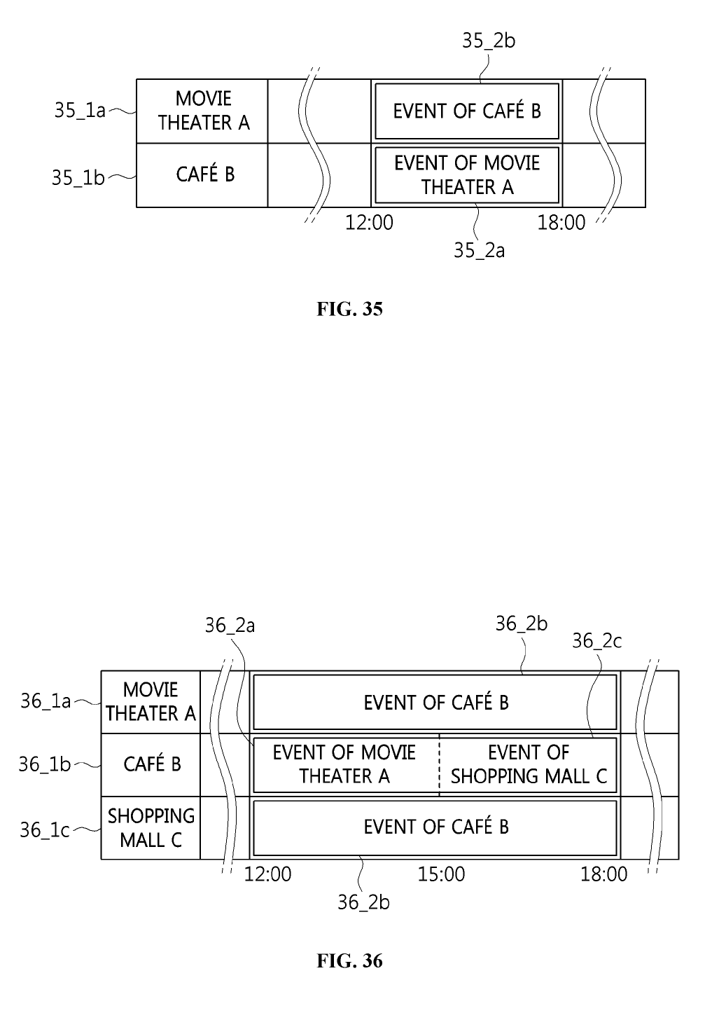

FIG. 35 is a view that shows an example of an advertising schedule arranged as the result of exchange of media in an embodiment of the present invention.

Specifically, FIG. 35 shows the advertising schedule 35_1a of movie theater A, and the advertising schedule 35_1b of café B from 12:00 to 18:00.

Referring to FIG. 35, the advertising media of movie theater A shows the event 35_2b of café B from 12:00 to 18:00, and the advertising media of café B shows the event 35 2a of movie theater A from 12:00 to 18:00.

This example may correspond to the case in which, when the exchange ratio is set to 1:1 because the value of the advertising media of movie theater A is equal to that of café B, media are exchanged by allocating each of the events to the other' s medium such that the events are shown during the same period, from 12:00 to 18:00.

Alternatively, this example may correspond to the case in which the value of the advertising media of movie theater A is not equal to that of café B but the exchange ratio is set to 1:1 by paying an additional expense corresponding to the difference. In this case, the media are exchanged such that the events are allocated in equal proportion so as to be shown during the same period, from 12:00 to 18:00.

As described above, two users exchange their media in a one-to-one manner, whereby each of the two users may show the other's events on its medium.

FIG. 36 is a view that shows an example of an advertisement schedule arranged as the result of the exchange of media in an embodiment of the present invention.

Specifically, FIG. 36 shows the advertising schedule 36_1a of movie theater A, the advertising schedule 36_1b of café B, and the advertising schedule 36_1c of shopping mall C from 12:00 to 18:00.

Referring to FIG. 36, the advertising media of movie theater A and the advertising media of shopping mall C may show the event 36_2b of café B from 12:00 to 18:00. The advertising media of café B may show the event 36_2a of movie theater A from 12:00 to 15:00, and may show the event 36_2c of shopping mall C from 15:00 to 18:00.

This example may correspond to the case in which the exchange ratio between the event 36 2a of movie theater A, the event 36 2b of café B, and the event 36_2c of shopping mall C is 1:2:1 because the value of the advertising media of café B is twice the value of the advertising media of each of movie theater A and shopping mall C.

Alternatively, this example may correspond to the case in which the advertising media of movie theater A, the advertising media of café B, and the advertising media of shopping mall C have equal value, but the exchange ratio between the event 36 2a of movie theater A, the event 36 2b of café B, and the event 36 2c of shopping mall C is set to 1:2:1 because each of the expense of the event 36_2a of movie theater A and the expense of the event 36_2c of shopping mall C is twice the expense of the event 36 2b of café B.

Alternatively, this example may correspond to the case in which each of the expense of the event 36_2a of movie theater A and the expense of the event 36_2c of shopping mall C is not twice the expense of the event 36_2b of café B but the exchange ratio is set to 1:2:1 because an additional expense corresponding to the difference of the expenses (values) is paid, whereby media are exchanged such that the events are allocated based on the exchange ratio from 12:00 to 18:00.

As described above, multiple users exchange their media, whereby each of the multiple users may show various events in one another's advertising media based on the set exchange ratio.

According to the present invention, a user may easily create an advertising event using the constructed content library. Also, the user may interchange his or her advertising media with that of another user such that the created advertising event may be shown in the advertising media of the other user, thereby more effectively providing the advertising event at low cost. Particularly, while determining the exchange target event, information about candidate events interchangeable with the user's event is provided, whereby more effective advertising media exchange may be supported, and the effect of the advertising event may be improved.

The above-described embodiment of the present invention may be implemented as program instructions executable by various computer devices, and may be recorded in computer-readable storage media. The computer-readable storage media may separately or collectively include program instructions, data files, data structures, and the like. The program instructions recorded in the media may be specially designed and configured for the embodiment, or may be available by being well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

According to the present invention, a user may cost-effectively run his or her event using the advertising media of another user through the apparatus and method for exchanging advertising media.

Also, through the apparatus and method for exchanging advertising media, the present invention calculates an exchange ratio in consideration of information about events and media such that the values of media and events are incorporated in the exchange ratio, whereby media may be reasonably exchanged.

Also, through the apparatus and method for exchanging advertising media, the present invention determines candidate events using the correlation between media, the correlation between events, the correlation of media with events, and the like, and determines the exchange target event from among the candidate events, whereby information about an event that is suitable to be interchanged may be provided to a user, and an advertising effect may be improved.

Also, through the apparatus and method for exchanging advertising media, the present invention enables an advertising event to be easily created merely by adding content obtained from a content library therein and to be interchanged with another advertising event through the exchange of advertising media, whereby an advertising event may be easily created, and may then be posted on another medium.

Also, through the apparatus and method for exchanging advertising media, the present invention enables an effective advertising event to be created for an advertiser based on collected statistical information and to be interchanged with another advertising event through the exchange of advertising media, whereby an advertising event expected to bring a good advertising effect may be effectively created, and may then be posted on another medium.

Although specific embodiments have been described in the specification, they do not limit the scope of the present invention. For the conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents will fall within the scope and spirit of the present invention.

What is claimed is:

1. An apparatus for exchanging advertising media, comprising:
a candidate event determining unit for determining one or more candidate events interchangeable with a prize event;
an exchange ratio determining unit for determining an exchange ratio between the prize event and an exchange target event to be interchanged therewith, which is determined based on the candidate events; and
a media exchange unit for allocating the prize event to an exchange target advertising media corresponding to the exchange target event based on the exchange ratio.

2. The apparatus of claim 1, wherein the candidate event determining unit determines the candidate events in consideration of one or more of a period factor calculated based on an event period of the prize event and an event period of the candidate event, a media utility factor of a prize event advertising media corresponding to the prize event and a candidate advertising media corresponding to the candidate event, and a prize factor calculated based on information about a prize of the prize event and a prize of the candidate event.

3. The apparatus of claim 2, wherein the exchange ratio determining unit determines the exchange ratio using a first exchange index corresponding to the prize event and a second exchange index corresponding to the exchange target event.

4. The apparatus of claim 3, wherein:
the first exchange index is calculated in consideration of one or more of information about the event period of the prize event, information about the prize of the prize event, and information about utility of the prize event advertising media, and
the second exchange index is calculated in consideration of one or more of information about an event period of the exchange target event, information about a prize of the exchange target event, and information about utility of the exchange target advertising media corresponding to the exchange target event.

5. The apparatus of claim 4, wherein the exchange ratio determining unit monitors progress status information of events during the event period of the prize event and updates the exchange ratio based on the progress status information within the event period.

6. The apparatus of claim 5, wherein the exchange ratio determining unit calculates a probability of winning the prize event during the event period of the prize event and updates the exchange ratio based on the probability within the event period.

7. The apparatus of claim 6, wherein, when a number of participants in the prize event does not reach a preset level during the event period of the prize event, the exchange ratio determining unit updates the exchange ratio within the event period such that the prize event is more frequently shown as the probability of winning the prize event is higher.

8. The apparatus of claim 7, wherein the prize factor is calculated based on a prize evaluation index that is calculated by dividing a value of a total prize of an event by a number of winners.

9. The apparatus of claim 8, further comprising:
an expense calculation unit for calculating an expense including one or more of a fee for exchange of the advertising media and an additional expense incurred during the exchange of the advertising media.

10. The apparatus of claim 9, wherein the exchange ratio is set to a ratio between exchange indices, a preset preference ratio, or a ratio of exchange indices modified by incorporating a preset additional expense therein.

11. A method for exchanging advertising media, comprising:
determining one or more candidate events interchangeable with a prize event;
determining an exchange ratio between the prize event and an exchange target event to be interchanged therewith, which is determined based on the candidate events; and
allocating the prize event to an exchange target advertising media corresponding to the exchange target event based on the exchange ratio.

12. The method of claim 11, wherein determining the one or more candidate events is configured to determine the candidate events in consideration of one or more of a period factor calculated based on an event period of the prize event and an event period of the candidate event, a media utility factor of a prize event advertising media corresponding to the prize event and a candidate advertising media corresponding to the candidate event, and a prize factor calculated based on information about a prize of the prize event and a prize of the candidate event.

13. The method of claim 12, wherein determining the exchange ratio is configured to determine the exchange ratio using a first exchange index corresponding to the prize event and a second exchange index corresponding to the exchange target event.

14. The method of claim 13, wherein:
the first exchange index is calculated in consideration of one or more of information about the event period of the prize event, information about the prize of the prize event, and information about utility of the prize event advertising media, and
the second exchange index is calculated in consideration of one or more of information about an event period of the exchange target event, information about a prize of the exchange target event, and information about utility of the exchange target advertising media corresponding to the exchange target event.

15. The method of claim 14, wherein determining the exchange ratio is configured to monitor progress status information of events during the event period of the prize event and to update the exchange ratio based on the progress status information within the event period.

16. The method of claim 15, wherein determining the exchange ratio is configured to calculate a probability of winning the prize event during the event period of the prize event and to update the exchange ratio based on the probability within the event period.

17. The method of claim 16, wherein determining the exchange ratio is configured such that, when a number of participants in the prize event does not reach a preset level during the event period of the prize event, the exchange ratio is updated within the event period so as to show the prize event more frequently as the probability of winning the prize event is higher.

18. The method of claim 17, wherein the prize factor is calculated based on a prize evaluation index that is calculated by dividing a value of a total prize of an event by a number of winners.

19. The method of claim 18, further comprising:
calculating an expense including one or more of a fee for exchange of the advertising media and an additional expense incurred during the exchange of the advertising media.

20. The method of claim 19, wherein the exchange ratio is set to a ratio between exchange indices, a preset preference ratio, or a ratio of exchange indices modified by incorporating a preset additional expense therein.
